(19) United States
(12) Patent Application Publication
(10) Pub. No.: US 2026/0064123 A1
(43) Pub. Date: Mar. 5, 2026

(54) CALCULATION DEVICE AND MOBILE ROBOT

(71) Applicant: Panasonic Intellectual Property Management Co., Ltd., Osaka (JP)

(72) Inventor: Fabio DALLA LIBERA, Osaka (JP)

(21) Appl. No.: 19/379,928

(22) Filed: Nov. 5, 2025

Related U.S. Application Data
(63) Continuation of application No. PCT/JP2024/014573, filed on Apr. 10, 2024.

(30) Foreign Application Priority Data
May 15, 2023 (JP) 2023-080319

(51) Int. Cl. G05D 1/43; G05D 1/229

(52) U.S. Cl. CPC G05D 1/43; G05D 1/229

(57) ABSTRACT

A calculation device includes an acquirer that acquires a first location and a second location different from the first location, and a calculator that computes a first movement path of a mobile robot that moves autonomously from the first location to the second location. The calculator computes a first movement path to connect the first location and the second location by a biarc.

### CROSS REFERENCE TO RELATED APPLICATIONS

This is a continuation application of PCT International Application No. PCT/JP2024/014573 filed on Apr. 10, 2024, designating the United States of America, which is based on and claims priority of Japanese Patent Application No. 2023-080319 filed on May 15, 2023. The entire disclosures of the above-identified applications, including the specifications, drawings and claims are incorporated herein by reference in their entirety.

### FIELD

The present disclosure relates to a calculation device for computing a movement path of an autonomous mobile robot, and to the mobile robot.

### BACKGROUND

Patent Literature (PTL) 1 discloses a method of determining a movement path along which an autonomous mobile robot moves.

### CITATION LIST

### Patent Literature

PTL 1: U.S. patent Ser. No. 11/429,105
PTL 2: U.S. Pat. No. 8,612,084

### Non Patent Literature

NPL 1: Stentz, A., “Optimal and efficient path planning for partially known environments”, Springer, Intelligent unmanned ground vehicles, Boston, Massachusetts, 1997, p. 203-220
NPL 2: McNaughton, M., Urmson, C., Dolan, J. M. and Lee, J. W., “Motion planning for autonomous driving with a conformal spatiotemporal lattice”, IEEE, International Conference on Robotics and Automation, 2011, May, p. 4889-4895
NPL 3: Bolton, K. M., “Biarc curves”, Computer-Aided Design, Volume 7, Issue 2, 1975, p. 89-92
NPL 4: Sir, Z., Feichtinger, R. and Juttler, B., “Approximating curves and their offsets using biarcs and Pythagorean hodograph quintics”, Computer-Aided Design, Volume 38, Issue 6, 2006, p. 608-618
NPL 5: Su, B. Q. and Liu, D. Z., “Computational Geometry: curve and surface modeling”, Academic Press Professional, Inc., 1989

### SUMMARY

### Technical Problem

Mobile robots of this kind are desired to reduce throughput in autonomous movement of the mobile robots.

The present disclosure provides a calculation device or the like capable of reducing throughput in autonomous movement of a mobile robot.

### Solution to Problem

A calculation device according to one aspect of the present disclosure is a calculation device that includes an acquirer that acquires a first location and a second location different from the first location, and a calculator that computes a first movement path of a mobile robot that moves autonomously from the first location to the second location. The calculator computes the first movement path to connect the first location and the second location by a biarc.

A mobile robot according to one aspect of the present disclosure is a mobile robot that includes the calculation device described above, and a controller that causes the mobile robot to move along the movement path computed by the calculation device.

### Advantageous Effects

The calculation device or the like according to one aspect of the present disclosure is capable of reducing throughput in autonomous movement of a mobile robot.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for describing a movement path of a mobile robot.

FIG. 2 is a diagram for describing the movement path of the mobile robot.

FIG. 3 is a diagram for describing a hitbox.

FIG. 4 is a diagram for describing a method of setting a hitbox.

FIG. 5 is a diagram for describing continuity.

FIG. 6 is a diagram for describing lattices.

FIG. 7 is a diagram for describing a movement path of the mobile robot.

FIG. 8A is a diagram for describing a biarc type.

FIG. 8B is a diagram for describing the biarc type.

FIG. 8C is a diagram for describing the biarc type.

FIG. 8D is a diagram for describing the biarc type.

FIG. 9 is a diagram for describing a biarc.

FIG. 10 is a diagram for describing the movement path of the mobile robot.

FIG. 11 is a diagram for describing the movement path of the mobile robot.

FIG. 12 is a diagram for describing the movement path of the mobile robot.

FIG. 13 is a graph showing a curvature relative to a.

FIG. 14 is a graph showing a path length relative to a.

FIG. 15 is a graph showing a curvature relative to a.

FIG. 16 is a graph showing a path length relative to a.

FIG. 17 is a diagram for describing re-computation of the movement path of the mobile robot.

FIG. 18 is a diagram for describing the re-computation of the movement path of the mobile robot.

FIG. 19 is a diagram for describing the re-computation of the movement path of the mobile robot.

FIG. 20 is a diagram for describing the re-computation of the movement path of the mobile robot.

FIG. 21A is a flowchart showing a specific example of processing for computing whether the mobile robot will collide with an obstacle.

FIG. 21B is a flowchart showing a specific example of processing for computing whether the mobile robot will collide with an obstacle.

FIG. 21C is a flowchart showing a specific example of processing for computing whether the mobile robot will collide with an obstacle.

FIG. 22 is a flowchart showing a specific example of processing for computing whether the mobile robot will collide with an obstacle.

FIG. 23 is a diagram for describing a specific example of processing for computing whether the mobile robot will collide with an obstacle.

FIG. 24 is a flowchart showing a specific example of processing for computing whether the mobile robot will collide with an obstacle.

FIG. 25 is a block diagram showing a configuration of the mobile robot according to the embodiment.

FIG. 26 is a flowchart showing a processing procedure performed by the mobile robot according to the embodiment.

### DESCRIPTION OF EMBODIMENT

### Underlying Knowledge Forming Basis of the Present Disclosure

Path planning for computing a movement path of a mobile robot usually entails high computational cost. Therefore, powerful hardware is normally used as can be seen in PTL 1.

For mobile robots, the space of movement is a space of continuous curves in a plane. Thus, this space is infinitely dimensional. Defining a graph is the standard approach normally adopted to compute the movement path. Each node corresponds to a condition of the mobile robot. The nodes usually represent the locations of the mobile robot in a plane.

Each node also represents the orientation of the mobile robot in many cases. Each node may further include other information such as the time of arrival of the mobile robot at a designated place and the steering angle of the mobile robot.

Nodes are connected by edges. Each edge represents a path that connects corresponding nodes. For each edge, for example, associated computational cost may be defined and set from perspectives such as the time required for the mobile robot to move between two nodes, a risk of collision of the mobile robot with an external object (also referred to an obstacle), and desirability of the edge.

For example, to express that the mobile robot cannot move from node A to node B, no edge from node A to node B is added, or an edge that requires infinite computational cost is added. For example, in the case where the path from node A to node B is blocked by an obstacle, there is no edge that connects nodes A and B.

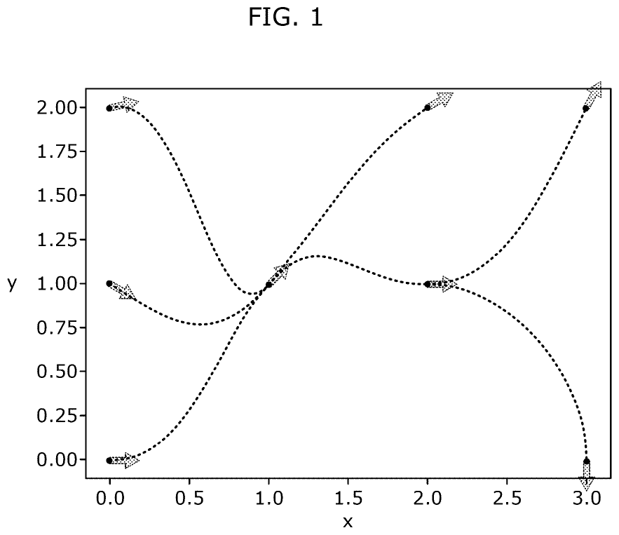

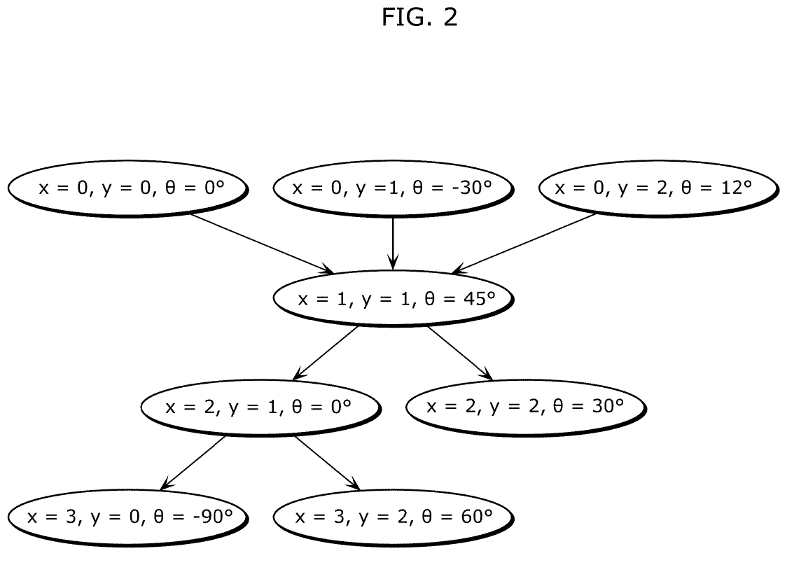

FIGS. 1 and 2 are diagrams for describing the movement path of a mobile robot. Specifically, FIG. 1 is a diagram showing a specific example of a set of locations and orientations of the mobile robot in a given space, and a specific example of a path that connects nodes in the space. FIG. 2 is a graph showing the location of each node shown in FIG. 1 and the orientation of the mobile robot when the mobile robot has moved to that location.

In FIG. 1, the locations in the given space are indicated by the horizontal and vertical axes, and both of the horizontal and vertical axes indicate the locations (e.g., distances (m) from the origin point of the coordinate system, i.e., a reference location, shown in FIG. 1).

For example, when a graph as shown in FIG. 2 is given to the mobile robot, a path on the graph is computed by using search algorithms such as A* and D* (see, for example, NPL 1), and the mobile robot can move along a path corresponding to the computed path in the physical world.

Determination as to whether the mobile robot will collide with an obstacle is normally defined depending on whether a hitbox set for the mobile robot intersects with any object.

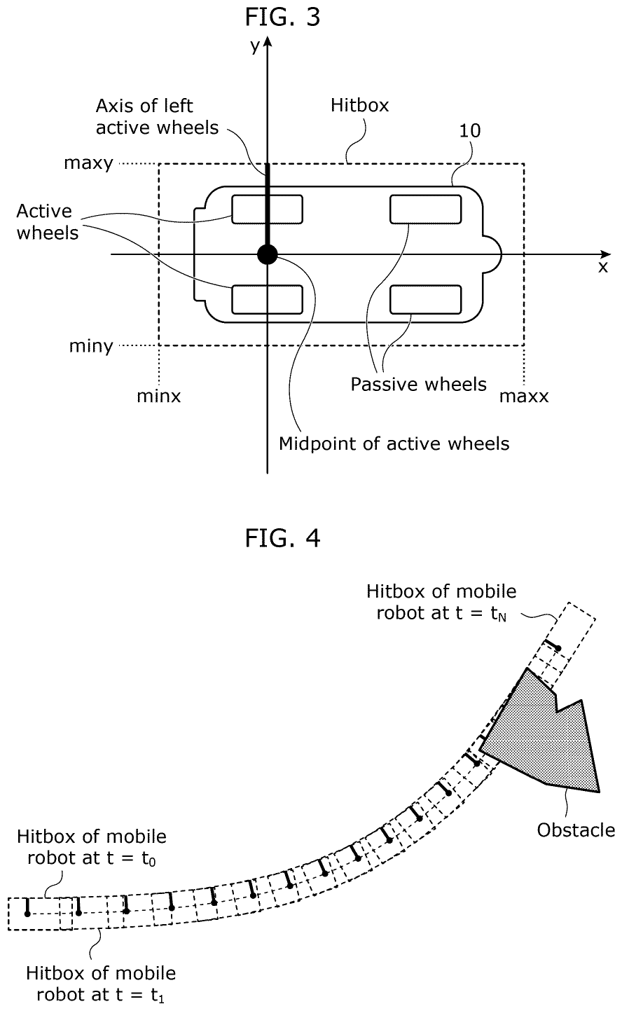

FIG. 3 is a diagram for describing a hitbox.

An obstacle refers to a substance that interferes with the movement of mobile robot 10. Examples of the obstacle include walls, people, and other mobile robots.

For example, there are cases where the location or the like of an obstacle is known beforehand because the obstacle is static, and where mobile robot 10 detects an obstacle during movement by using a device as a camera or a light detection and ranging (LIDAR).

The hitbox normally has a polygonal shape and is set to become slightly larger than the size of mobile robot 10 (mobile robot space required). If an obstacle enters the hitbox set for mobile robot 10 while mobile robot 10 is moving, the path, i.e., the computed movement path, is considered invalid.

In the following description, the mobile robot may be indicated by using a hitbox. To clarify the orientation of the mobile robot, information about the axis of the left active wheels of the mobile robot relative to the movement direction of the mobile robot is also acquired.

The active wheels refer to wheels that are actively rotated by a motor or the like to move the mobile robot. Passive wheels refer to wheels that are not actively rotated by the motor or the like.

The active wheels may, for example, be rear wheels, but may also be front wheels or any arbitrary wheels.

A path in the real world that corresponds to an edge on the graph is normally defined by a spline; in most cases, a cubic Bezier spline (see, for example, PTL 2). In the case where a path is defined by a spline, sampling is normally used in order to compute whether the mobile robot will collide with an obstacle.

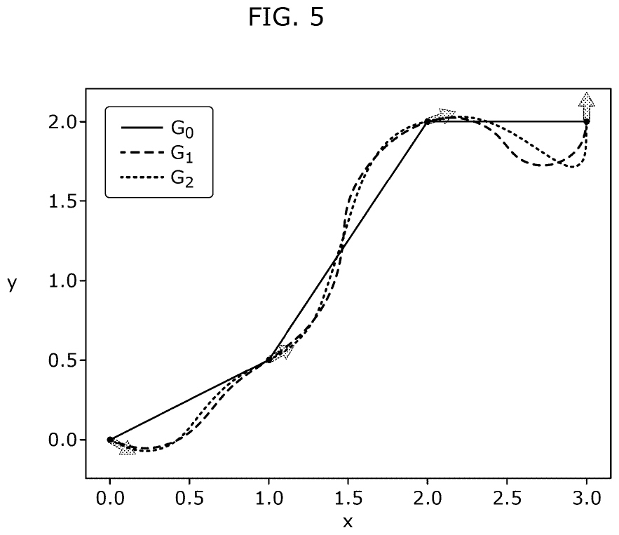

FIG. 4 is a diagram for describing a method of setting a hitbox.

The location of the mobile robot that moves along a path is computed at a series of times t=t0, t1, . . . , and tn. At each time t, it is computed whether the hitbox of the mobile robot will intersect with an obstacle.

Such sampling entails high computational cost. According to the present disclosure, continuous paths corresponding to edges are defined by a method that does not require sampling as described above to compute whether the hitbox will collide with an obstacle.

The continuous paths are normally defined by a cubic Bezier spline. Specifically, control points of the spline are selected so as to have G₂ continuity when two paths merge at a node. That is, the use of the spline allows location (G₀ continuity), tangent (G₁ continuity), and curvature (G₂ continuity) to become continuous at joint points of the edges.

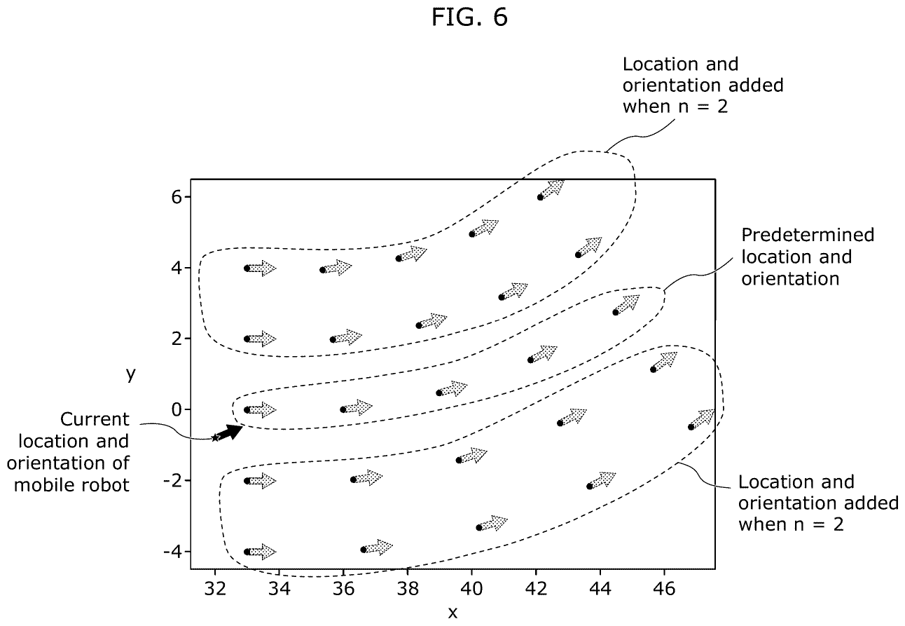

FIG. 5 is a diagram for describing continuity. In the example shown in FIG. 5, continuity at four points, each specifying a pose (the location indicated by a black point in FIG. 5 and the orientation indicated by the arrow starting from the black point), is connected by using continuity curves of different levels. The solid line in FIG. 5 shows the case where the four points (four waypoints) are connected with G₀ continuity. The broken line in FIG. 5 shows the case where the four points are connected with G₁ continuity. The dotted line in FIG. 5 shows the case where the four points are connected with G₂ continuity.

Ackerman steering requires G₂ continuity, but many types of mobile robots such as holonomic robots, differential drive robots, and skid-steering robots do not require G₂ continuity for their movement path. In actuality, G₀ continuity is sufficient for the movement paths of these types of mobile robots. For example, the mobile robot can rotate in situ on the straight path with G₀ continuity indicated by the solid line in FIG. 5. Such a simple movement path is often used in robotics in order to compute the movement path. The computed movement path is normally the shortest path. However, the mobile robot that moves (travels) along such a movement path needs to completely stop at each waypoint, requiring frequent acceleration and deceleration. This increases the movement time of the mobile robot in many cases.

The present disclosure provides the method of generating (computing) a path (movement path) by using a biarc that is a curve with G₁ continuity, and a method of creating a significantly efficient algorithm in order to determine (detect) on the basis of such curves whether a mobile robot will collide with an obstacle. Therefore, according to the present disclosure, the generation of such a movement path eliminates the need for the mobile robot that moves along the generated movement path to completely stop at each waypoint, and also keeps low the computational cost of determining whether the mobile robot will collide with an obstacle.

An embodiment will be described hereinafter in detail with reference to the drawings.

Note that each embodiment described below illustrates a generic or specific example of the present disclosure. Numerical values, shapes, materials, constituent elements, arrangement locations and connection forms of constituent elements, steps, a sequence of steps, and so on in the following embodiments are mere examples and do not intend to limit the scope of the present disclosure. Among the constituent elements described in the following embodiments, those that are recited in none of the independent claims, which represent the broadest concept, are described as optional constituent elements. Each drawing is a schematic diagram and does not necessarily provide precise depiction. Throughout the drawings, the same constituent elements are given the same reference signs.

In the specification of the present disclosure, ordinal numbers such as “first” and “second” do not refer to the number or sequence of constituent elements, unless otherwise specified, and are used to avoid confusion with the same type of constituent elements and to distinguish them from one another.

In the specification of the present application, characters such as boldface characters, knockout characters, or italicized characters in mathematical expressions may be written without being such characters.

### EMBODIMENT

### Overview

A method described in present embodiment is very common and applicable to various settings that require planning (computation of a movement path). For example, such planning may be executed only once when environments are static, i.e., there are no moving obstacles, or may be executed regularly when environments are dynamic, i.e., there are moving obstacles. For example, such planning may be executed at the starting point of the mobile robot's movement, during movement of the mobile robot, or at the end point of the mobile robot's movement. Alternatively, such planning may also be executed online beforehand by a server or the like that communicates with the mobile robot. In the case where such planning is executed beforehand by a server or the like, the server or the like transmits information indicating the movement path to the mobile robot.

The present embodiment describes online planning. The location of an obstacle is assumed to change possibly while the mobile robot is moving. It is also assumed that the movement path of the mobile robot is not perfect due to factors such as sensing noise or irregularity in the pavement of a floor surface on which the mobile robot moves. Therefore, the present embodiment assumes periodic re-computation (re-planning) of the movement path from the current pose of the mobile robot to the pose at the point of arrival.

In such re-planning, it is desirable in many cases that a movement path computed by re-planning is made closer to the previous movement path. If the movement path considerably changes at each time, the mobile robot may make jerky movements. Therefore, the following description gives two cases. The first case is initial planning in which every movement path (a movement path configured as a biarc) can be selected arbitrarily. The second case is re-planning in which the preciously computed movement path is used to compute a new movement path.

Firstly, a specific example of computing a movement path will be described.

The current (initial) pose of the mobile robot, i.e., the current location and orientation of the mobile robot, are assumed to be already known. Also, N waypoints (where N is an integer greater than or equal to one) are assumed to be defined in advance. Each waypoint represents a pose that the mobile robot is supposed to make while moving to the last destination in the case where there are no obstacles. In many cases, the waypoints are a sequence of poses that correspond to the center of the road surface on which the mobile robot moves. These N waypoints may be stored in advance in the mobile robot, or may be transmitted to the mobile robot from a server or the like. For example, N waypoints may be automatically acquired from a map of the place where the mobile robot moves.

A lattice (lattice information) is generated from these waypoints. The waypoints may be arranged to form a lattice (rectangular lattice) that connects the waypoints, or may be arranged to form, for example, a conformal lattice (see, for example, NPL 2) that is a deformed rectangular lattice like conformal mapping of a rectangular lattice.

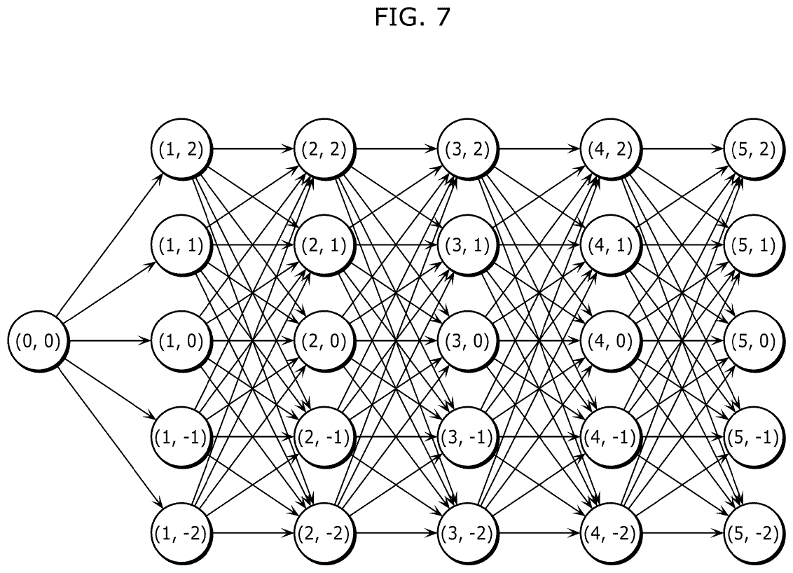

FIG. 6 is a diagram for describing lattices. Specifically, FIG. 6 shows an example of the pose at each waypoint for N=5, and the physical location and orientation at each node (i.e., the pose at each waypoint) in a lattice that is added for n=2. In FIG. 6, each pose of the mobile robot when starting to move is indicated by a black star and an arrow at the location of the black star.

In the computation of the movement path, for example, a sequence (layer) of a plurality of new poses is added by using n on both sides of a predetermined sequence of a plurality of poses as shown in FIG. 6. For example, n may be arbitrarily set by a user.

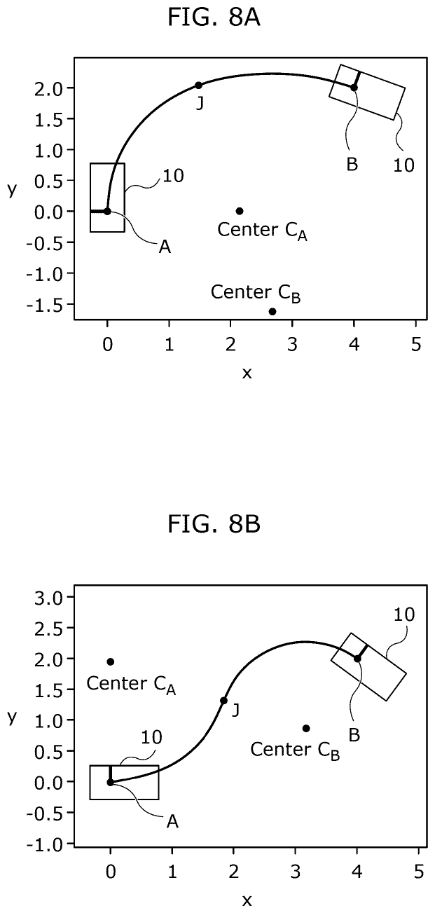

FIG. 7 is a diagram for describing the movement path of the mobile robot. Specifically, FIG. 7 is a diagram showing a graph corresponding to FIG. 6.

Each node (lattice point) in the lattice is indexed using a pair (i, j), where 1≤i≤N and −n≤j≤n. Node (0, 0) is used to indicate the pose of the mobile robot when starting to move. For example, the pose of the mobile robot when starting to move in FIG. 6 corresponds to (0, 0) shown in FIG. 7.

A graph search algorithm such as A* is used to find a path from node (0, 0) to node (N, j). Note that only a subset of these nodes (nodes corresponding to newly added waypoints) may be considered, or only (N, 0) may be considered as the point of arrival. It is also assumed that only edges in the form of −h≤k≤h are present from node (i, j) to node (i+1, k). In the case where an edge that connects nodes (i, j) and (i+1, k) is a path in which the mobile robot will not collide with an obstacle, a computational cost equal to 1+|j|+|k| is set for this edge, and an infinite computational cost is assigned to the other edges. With this assignment of computational costs, the movement path can be computed by prioritizing waypoints that are close to each waypoint indicating a predetermined location and orientation and at which the mobile robot will not collide with an obstacle.

As described above, in the case where each edge is indicated by a biarc, i.e., in the case where a path connecting each waypoint are configured as a biarc, determination as to whether the mobile robot will collide with an obstacle (also referred to as collision determination) can be executed efficiently. The following description firstly gives how a biarc is generated and then gives how collision determination is made.

### [Definition of Biarc]

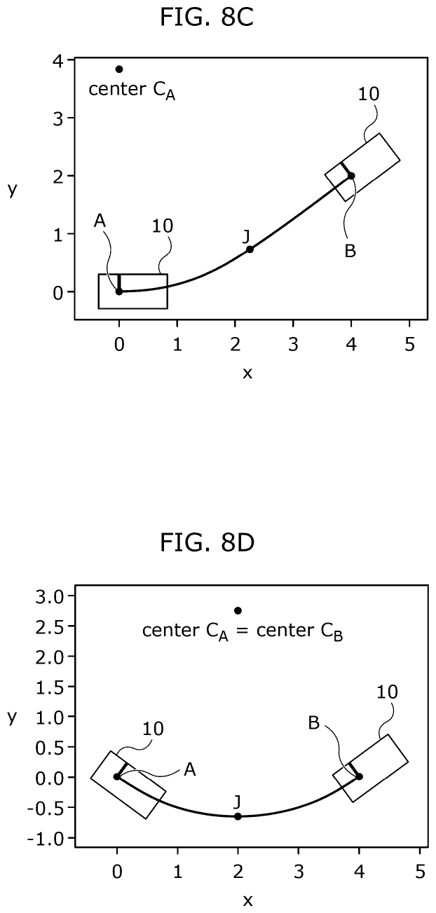

FIGS. 8A to 8D are diagrams for describing biarc types.

A biarc (two-arc) curve (also simply referred to as a biarc) is a line configured by two arcs. Specifically, the biarc is a series of lines (i.e., a continuous curve or straight line) that connects the end point of one of two arcs and the end point of the other arc (i.e., connect the end points of the two arcs). In FIGS. 8A to 8D, the rotation centers of the two arcs are indicated by C_{A} and C_{B}. The two arcs are joined (i.e., connected) by a point indicated by J, i.e., a joint point. The two arcs are selected so as to have their tangents at the point J on the same straight line. For example, the rotation centers of the two arcs may be located on the same side with respect to the biarc as shown in FIG. 8A. Alternatively, the rotation centers of the two arcs may be located on the opposite sides with respect to the biarc as shown in FIG. 8B. Note that at least one of the two arcs may have an infinite radius (radius of curvature). In this case, this arc becomes a straight line as shown in FIG. 8C. At least one of the two arcs may be a straight line (i.e., with an infinite radius of curvature), or both of the two arcs may be straight lines. In the case where the two arcs have infinite radii of curvature, the biarc becomes a straight line. As another alternative, the rotation centers of the two arcs may match. In this case, the biarc becomes a single arc as shown in FIG. 8D.

Even if the computation of the biarc results in cases such as where one of the two arcs of the biarc becomes a straight line or where the two arcs serve as a single arc, this biarc may still be referred to as a biarc. Moreover, even if the computation of each arc results in cases such as where the arc becomes a straight line, this arc may still be referred to as an arc.

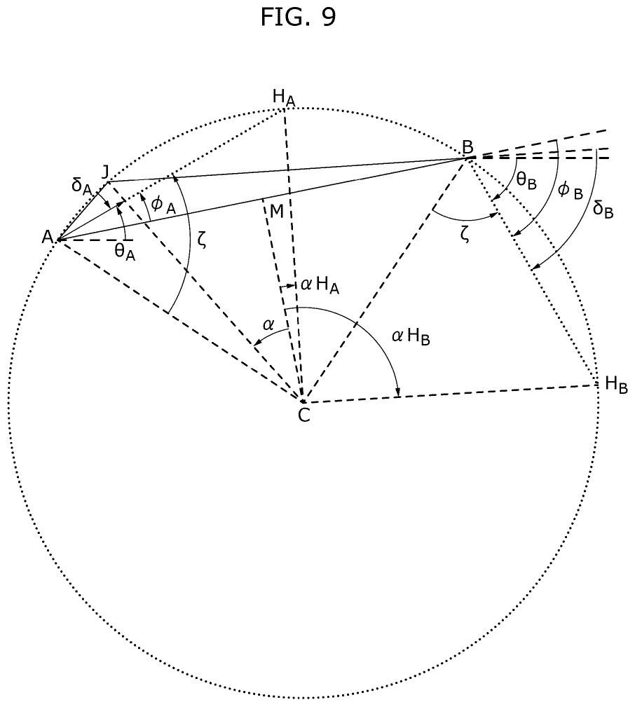

FIG. 9 is a diagram for describing a biarc. Specifically, FIG. 9 is a diagram for describing the definition of each symbol described below. In FIG. 9, a circle with its center at point C is indicated by a dotted line.

For example, initial location A of the mobile robot (also referred to as point A), orientation θ_{A} of the mobile robot at location A, final location B of the mobile robot (also referred to as point B) that is a target destination point, and orientation θ_{B} of the mobile robot at location B are assumed to be defined in advance. In this case, there are infinite possibilities for selecting point J. Here, definitions are given as follows.
φ_{A} that indicates the orientation of the mobile robot at point A is defined as −π<φ_{A}≤π as the angle from line segment AB.
φ_{B} that indicates the orientation of the mobile robot at point B is defined as −π<φ_{B}≤π as the angle from line segment AB.

$$γ = {φ}_{B} - {φ}_{A}$$

is defined.
Unit vector u that indicates the orientation from point A to point B is defined as:

$$u = [ \begin{matrix}{u}_{x} \\ {u}_{y}\end{matrix} ] \qquad [ Expression 1 ]$$

A unit vector orthogonal to unit vector u is defined as:

$$v = [ \begin{matrix}{v}_{x} \\ {v}_{y}\end{matrix} ] \qquad [ Expression 2 ]$$

The length of line segment AB is defined as |AB|.
For example, M=A+(|AB|/2)×unit vector u is defined, where M is the midpoint of line segment AB.
Point C is defined as:

$$C = \{ \begin{matrix}M + \frac{\vert AB \vert}{2} \frac{v}{tan ( \frac{γ}{2} )} & if γ \neq k π , k ∈ ℤ \\ M & if γ = π + k 2 π\end{matrix} \qquad [ Expression 3 ]$$

If the orientation of the mobile robot is different before and after moving, i.e., γ≠k2π (k∈Z, where Z is a set of all integers), point J is selected from among arbitrary points on a circle with center C and a radius of |AC|=|BC| (see, for example, NPL 3). On the other hand, if the orientation of the mobile robot is the same before and after moving, i.e., γ=k2π (k∈Z), point J is selected from among arbitrary points on straight line AB.

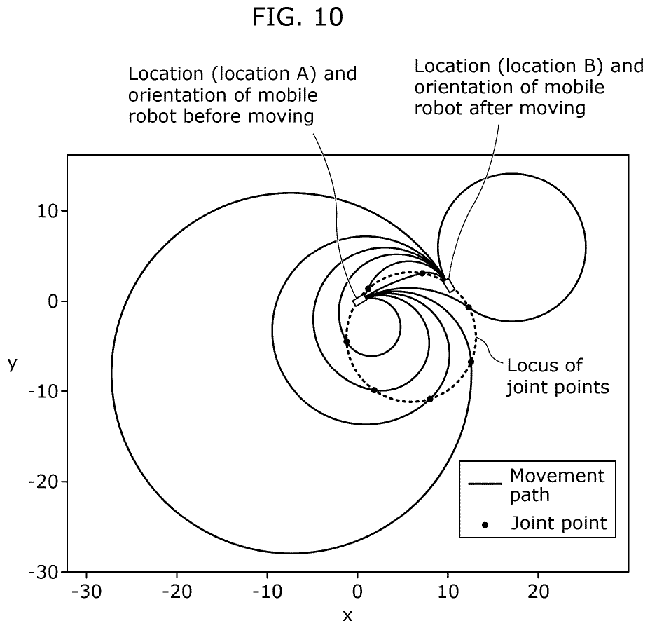

FIGS. 10 to 12 are diagrams for describing the movement path of the mobile robot.

FIG. 10 shows how various biarcs are used, i.e., the results of selecting various points J, in order to move the location and orientation of the mobile robot from A and θ_{A} to B and θ_{B} while the mobile robot moves from initial location A to final location B when γ≠k2π. The solid lines shown in FIG. 10 indicate specific examples of movement paths that can be computed. The dotted line shown in FIG. 10 indicates the locations of point J that can be taken.

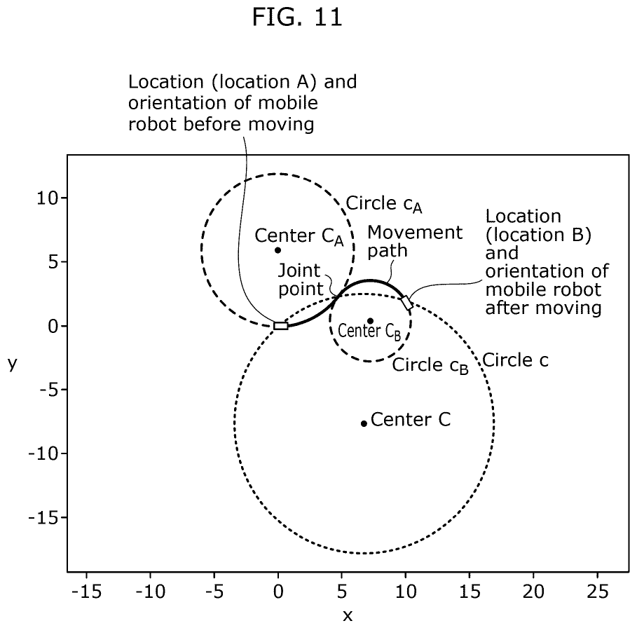

FIG. 11 shows a biarc in the case of determining a biarc from two circles. The solid line shown in FIG. 11 indicates a specific example of a biarc (movement path) to be computed. The first arc of the biarc (the arc from the location of the mobile robot before moving to a joint point shown in FIG. 11) is part of circle c_{A} with center C_{A}. The second arc of the biarc (the arc from the joint point to the location of the mobile robot after moving shown in FIG. 11) is part of circle c_{B} with center C_{B}. The locus of the joint points (the locus of locations that can be joint points) forms circle c with center C as indicated by the dotted line in FIG. 11. For example, in the case where these three circles have infinite radii, the arcs have infinite radii of curvature and become straight lines.

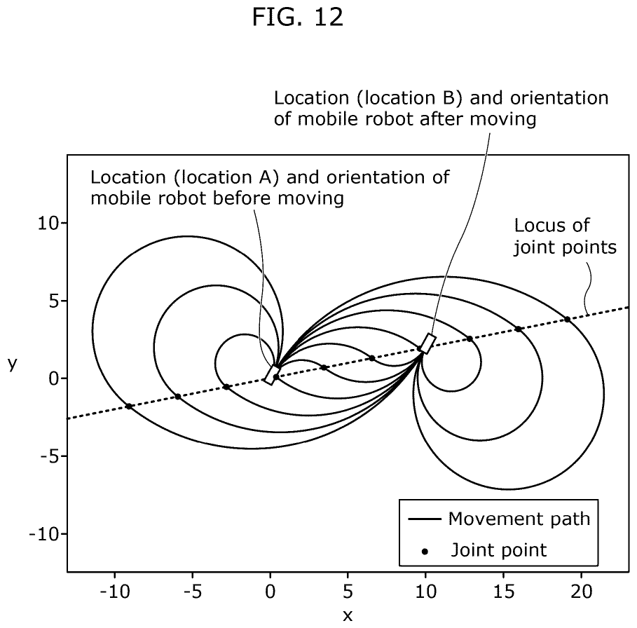

FIG. 12 shows how various biarcs are used, i.e., the results of selecting various points J, in order to move the location and orientation of the mobile robot from A and θ_{A} to B and θ_{A}, i.e., when the orientation of the mobile robot is the same before and after moving, while the mobile robot moves from initial location A to final location B. The solid lines shown in FIG. 12 indicate specific examples of movement paths that can be computed. The dotted line shown in FIG. 12 indicates the location of point J that can be taken.

### Selection of J in Initial Planning

Next, a method of selecting point J will be described. Here, additional definitions are given as follows.
The length of the arc from point A to point J is defined as:

$${l}_{A} = \vert \vert ( hereinafter , is also expressed as arc AB ) \qquad [ Expression 4 ]$$

The length of the arc from point B to point J is defined as l_{B}=|arc JB|.
A total length of the biarc is defined as l and, for example, l=l_{A}+l_{B}.
r_{A} is defined as the signed radius of the arc from point A to point J.
r_{B} is defined as the signed radius of the arc from point B to point J.

Note that the positive radius corresponds to counterclockwise rotation of the mobile robot, and the negative radius corresponds to clockwise rotation of the robot. The terms clockwise and counterclockwise as used herein refer to the direction of rotation on the graph. For example, when the mobile robot is viewed from above, clockwise refers to the direction of rotation to the left and counterclockwise refers to the direction of rotation to the right.
k_{A}=1/r_{A} is defined as the signed curvature of the arc from point A to point J.
k_{B}=1/r_{B} is defined as the signed curvature of the arc from point B to point J.

As described above, in order to minimize acceleration required for the mobile robot during movement, it is desirable to minimize discontinuity of the curvature. To select point J so as to lower the discontinuity of the curvature, it is necessary at the same time to limit the length of the movement path. If point J is selected to lower the discontinuity of the curvature, the movement path may become fairly long. Hereinafter, description is given of the case where γ≠k2π (the orientation of the mobile robot is different before and after moving) and the case where γ=k2π (the orientation of the mobile robot is the same before and after moving) with respect to a difference in curvature acquired for point J and the length of the movement path (path length).

[Selection of J in Initial Planning when γ≠k2π]

First, assume that γ≠k2π. Here, additional definitions are given as follows (see FIG. 9).
The angle formed from line segment CM to line segment CJ is defined as α.
The orientation of the mobile robot at point A is defined as −π≤δ_{A}<π as the angle from line segment AJ.
The orientation of the mobile robot at point B is defined as −π≤δ_{B}<π as the angle from line segment BJ.
The orientation of the mobile robot at point A is defined as ζ as the angle from line segment AC. This is equivalent to the angle of the mobile robot from line segment BC at point B (see NPL 4).
H_{A} is defined as the point of intersection with a circle other than point A on a straight line that passes point A and that has an orientation equal to the orientation of the mobile robot at point A. Here, H_{A}=A is satisfied when ζ=(π/2)+kπ(k∈Z), i.e., when the orientation of the mobile robot is in the tangential direction of the circle.

$${φ}_{M} = ( {φ}_{A} + {φ}_{B} ) / 2$$

The angle formed from line segment CM to line segment CH_{A} is defined as α_{HA}. That is, α_{HA}=φ_{M}+φ_{A}.
The angle formed from line segment CM to line segment CH_{B} is defined as α_{HB}. That is, α_{HB}=φ_{M}+φ_{B}.

From the above definitions, the following expressions are shown (see, for example, NPL 5).

$$\begin{matrix}[ Expression 5 ] & \\ {r}_{A} = \frac{\vert AB \vert}{2 sin ( \frac{γ}{2} )} \frac{sin ( \frac{α}{2} + \frac{γ}{4} )}{sin ( \frac{α}{2} - \frac{{α}_{{H}_{A}}}{4} )} & ( 2 )\end{matrix}$$

$$\begin{matrix}[ Expression 6 ] & \\ {r}_{B} = \frac{\vert AB \vert}{2 sin ( \frac{γ}{2} )} \frac{sin ( \frac{α}{2} - \frac{γ}{4} )}{sin ( \frac{α}{2} - \frac{{α}_{{H}_{B}}}{4} )} & ( 3 )\end{matrix}$$

$$\begin{matrix}[ Expression 7 ] & \\ {k}_{B} - {k}_{A} = \frac{2 sin ( \frac{γ}{2} )}{\vert AB \vert} \frac{cos ( {φ}_{B} ) - cos ( {φ}_{A} )}{cos ( \frac{γ}{2} ) - cos ( α )} & ( 4 )\end{matrix}$$

As can be seen from Expression (4), |k_{B}−k_{A}| has a local minimum value for α=kπ(k∈Z). Specifically, if cos(γ/2)<0, |k_{B}—k_{A}| becomes a minimum value at α=k2π, and if cos(γ/2)>0, |k_{B}—k_{A}| becomes a minimum value at α=π+k2π. If γ=π+k2π (i.e., cos(γ)=0), the two points have an absolute value of the same difference in curvature.

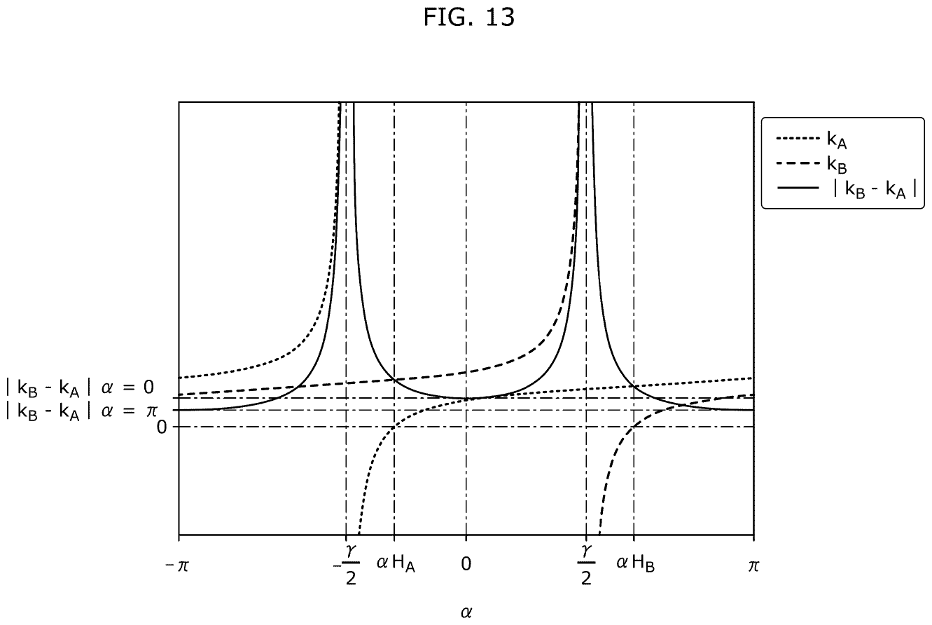

FIG. 13 is a graph showing curvatures relative to α. Specifically, FIG. 13 is a diagram showing an example of curvatures obtained for φ_{A}=−π/3 and φ_{B}=π/2, which corresponds to FIG. 10. Here, the path length is computed. From the law of sines, the following expressions are computed.

$$\begin{matrix}[ Expression 8 ] & \\ \vert AJ \vert = \vert AB \vert \vert \frac{sin ( \frac{α}{2} + \frac{γ}{4} )}{sin ( \frac{γ}{2} )} \vert & ( 5 )\end{matrix}$$

$$\begin{matrix}[ Expression 9 ] & \\ \vert JB \vert = \vert AB \vert \vert \frac{sin ( \frac{α}{2} - \frac{γ}{4} )}{sin ( \frac{γ}{2} )} \vert & ( 6 )\end{matrix}$$

Assuming that the unnormalized sinc function is defined as sinc(x), the following expressions are computed.

$$\begin{matrix}[ Expression 10 ] & \\ {l}_{A} = \frac{\vert AJ \vert}{sinc ( {δ}_{A} )} & ( 7 )\end{matrix}$$

$$\begin{matrix}[ Expression 11 ] & \\ {l}_{B} = \frac{\vert JB \vert}{sinc ( {δ}_{B} )} & ( 8 )\end{matrix}$$

If cos(ζ)=0 (cos(φ_{A}+φ_{B})=1 holds true), the following expression is computed.

$$\begin{matrix}[ Expression 12 ] & \\ l = \{ \begin{matrix}\frac{\vert AB \vert}{sinc ( \frac{γ}{2} )} & cos ( α ) \geq cos ( \frac{γ}{2} ) \\ \frac{\vert AB \vert \frac{γ}{2} + π}{sin ( \frac{γ}{2} )} & cos ( α ) < cos ( \frac{γ}{2} )\end{matrix} & ( 9 )\end{matrix}$$

In this way, a minimum path length is obtained for the value of α that satisfies cos(α)>cos(γ/2).

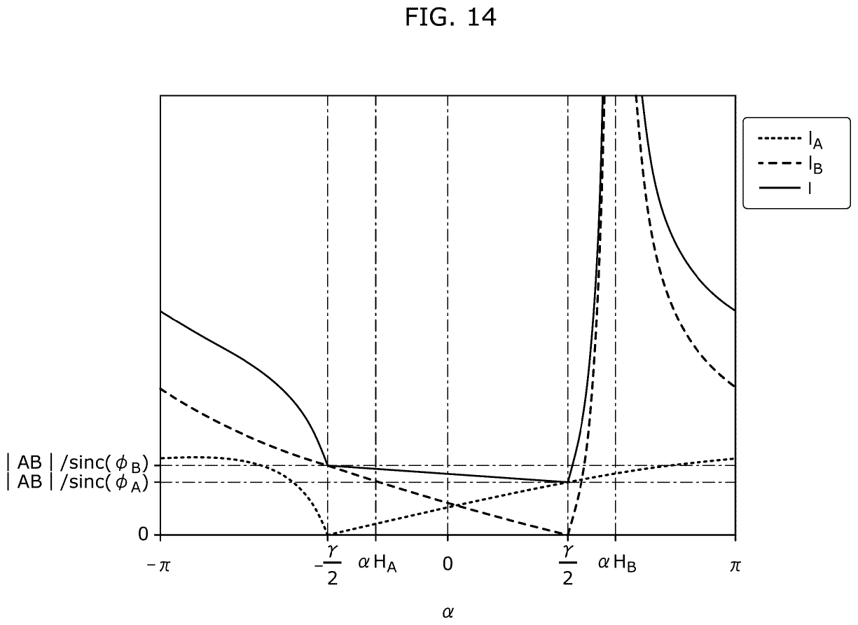

If cos(ζ)<0 is satisfied, l_{A} (thus, l) becomes infinite at α=α_{HA}. It can be shown that cos(ζ)<0 is equivalent to cos(φ_{B})>cos(φ_{A}). Similarly, if cos(ζ)>0 (i.e., cos(φ_{B})<cos(φ_{A})) is satisfied, l_{B} (thus, l) becomes infinite at α=α_{HB}. If α=−γ/2+k2π, i.e., if J=A, is satisfied, l=|AB|/sinc(φ_{B}) holds true. If α=γ/2+k2π, i.e., if J=B, is satisfied, l=|AB|/sinc(φ_{A}) holds true. Thus, the path length is a positive function of a and leans toward infinity at α=α_{HA}+k2π (when cos(φ_{B})>cos(φ_{A})) or at α=α_{HB}+k2π (when cos(φ_{B})>cos(φ_{A})), and is continuous at the other locations. The path length also becomes a minimum at α=−γ/2+k2π (when cos(φ_{B})>cos(φ_{A})) or at α=γ/2+k2π (when cos(φ_{B})<cos(φ_{A})). FIG. 14 is a graph showing the path length with respect to a. Specifically, FIG. 14 is a diagram showing one example of the path length obtained for φ_{A}=−π/3 and φ_{B}=π/2, which corresponds to FIG. 10.

The path length at α=0 is defined as l_{α=0}, and the path length at α=π is defined as l_{α=π} (two local minimum values of the difference in curvature). For any biarc, l_{α=0}<l_{α=π} is numerically computed for (PA and (PB that satisfy l_{α=0}<(4/3)l_{α=π} and −(40/41)π≤φ_{A}, φ_{B}≤(40/41). On the other hand, l_{α=0}>l_{α=π} is satisfied only when l_{α=π} is already fairly large. Specifically, l_{α=π}>80|AB| is satisfied for all cases where l_{α=0}>l_{α=π}.

Therefore, for cos(γ/2), the difference in curvature becomes a minimum value at α=π+k2π, but in the present embodiment, α=0 is selected for every biarc. Selecting α=0 means that point J is located on the bisector of line segment AB. Accordingly, the following expressions are computed.

$$\begin{matrix}[ Expression 13 ] & \\ {J}_{α = 0} = M - \frac{\vert AB \vert}{2} vtan ( \frac{γ}{4} ) & ( 10 )\end{matrix}$$

$$\begin{matrix}[ Expression 14 ] & \\ {\vert AJ \vert}_{α = 0} = {\vert JB \vert}_{α = 0} = \frac{\vert AB \vert}{2 cos ( \frac{γ}{2} )} & ( 11 )\end{matrix}$$

$$\begin{matrix}[ Expression 15 ] & \\ {l}_{{A}_{α = 0}} = \frac{{\vert AJ \vert}_{α = 0}}{sinc ( \frac{{α}_{{H}_{A}}}{2} )} & ( 12 )\end{matrix}$$

$$\begin{matrix}[ Expression 16 ] & \\ {l}_{{B}_{α = 0}} = \frac{{\vert JB \vert}_{α = 0}}{sinc ( \frac{{α}_{{H}_{B}}}{2} )} & ( 13 )\end{matrix}$$

$$\begin{matrix}[ Expression 17 ] & \\ {k}_{{A}_{α = 0}} = - \frac{2 ( sin ( {φ}_{M} + sin ( {φ}_{A} ) )}{\vert AB \vert} & ( 14 )\end{matrix}$$

$$\begin{matrix}[ Expression 18 ] & \\ {k}_{{B}_{α = 0}} = \frac{2 ( sin ( {φ}_{M} ) + sin ( {φ}_{B} ) )}{\vert AB \vert} & ( 15 )\end{matrix}$$

$$\begin{matrix}[ Expression 19 ] & \\ {k}_{{B}_{α = 0}} - {k}_{{A}_{α = 0}} = \frac{8 sin ( {φ}_{M} ) {cos}^{2} ( \frac{γ}{4} )}{\vert AB \vert} & ( 16 )\end{matrix}$$

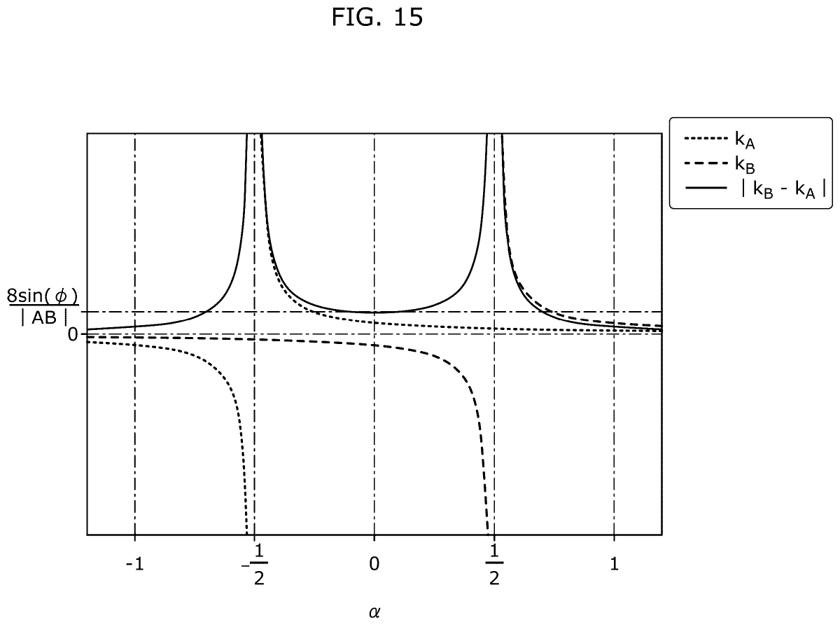

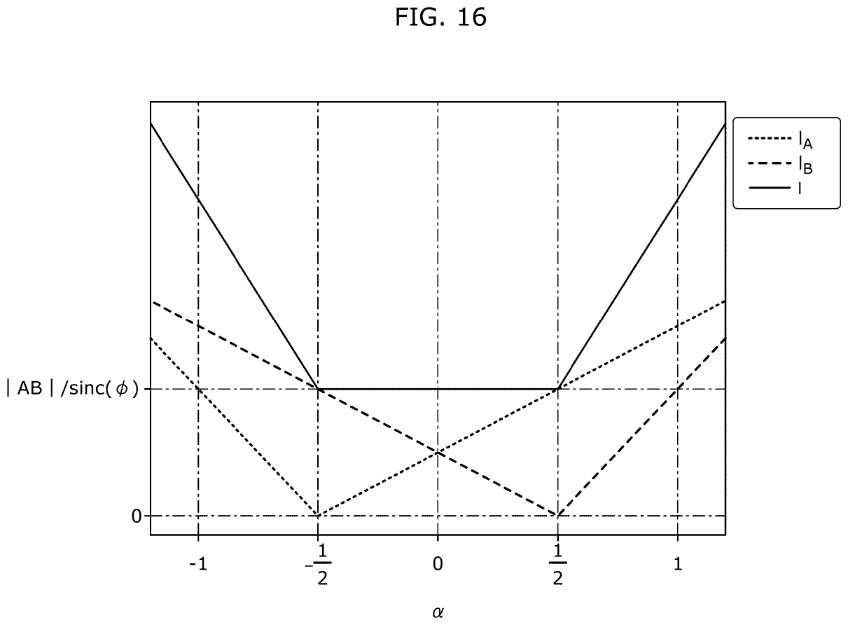

FIG. 15 is a graph showing curvatures relative to a. FIG. 16 is a graph showing path lengths relative to a. Specifically, FIGS. 15 and 16 are diagrams showing curvatures and path lengths relative to a, which corresponds to FIG. 12. The same as described above can also be said for FIGS. 15 and 16.

[Selection of J in Initial Planning when γ=k2π]

J is parametrized by a E R (R is a set of all real numbers). Point J is defined as follows.

$$\begin{matrix}[ Expression 20 ] & \\ J = A ( \frac{1}{2} - α ) + B ( \frac{1}{2} + α ) & ( 17 )\end{matrix}$$

In this way, J=A is satisfied at α=−½, and J=B is satisfied at α=½.

If γ=k2π, φ_{A}=φ_{B} is satisfied. k is defined to satisfy φ=φ_{A} and the following expression:

$$\overline{φ} = π - {φ}_{A} + k 2 π ( - π \leq \overline{φ} < π ) \qquad [ Expression 21 ]$$

The radius of curvature is computed as follows.

$$\begin{matrix}[ Expression 22 ] & \\ {r}_{A} = \vert AB \vert \frac{α + \frac{1}{2}}{- 2 sin ( φ )} & ( 18 )\end{matrix}$$

$$\begin{matrix}[ Expression 23 ] & \\ {r}_{B} = \vert AB \vert \frac{α - \frac{1}{2}}{- 2 sin ( φ )} & ( 19 )\end{matrix}$$

$$The difference in curvature is computed as follows .$$

$$\begin{matrix}[ Expression 24 ] & \\ {k}_{B} - {k}_{A} = \frac{2 sin ( φ )}{\vert AB \vert ( \frac{1}{4} - {α}^{2} )} & ( 20 )\end{matrix}$$

If φ=kπ, the radii of curvature are infinite, and the curvatures become zero. Thus, the difference in curvature becomes zero at any α. If φ≠kπ, curvature k_{A} becomes infinite at α=−½ (i.e., J=A), and curvature k_{B} becomes infinite at α=½ (i.e., J=B). The difference in curvature tends to become zero at |α|→∞. The difference in curvature has a local minimum value at α=0.

The path length is computed as follows.

$$\begin{matrix}[ Expression 25 ] & \\ {l}_{A} = \{ \begin{matrix}\vert AB \vert \frac{- \frac{1}{2} - α}{sin c \overline{( φ )}} & α < - \frac{1}{2} Λφ \neq 0 \\ \vert AB \vert \frac{\frac{1}{2} + α}{sin c ( φ )} & α \geq - \frac{1}{2} Λφ \neq π \\ ∞ & otherwise\end{matrix} & ( 21 )\end{matrix}$$

$$\begin{matrix}[ Expression 26 ] & \\ {l}_{A} = \{ \begin{matrix}\vert AB \vert \frac{\frac{1}{2} - α}{sin c \overline{( φ )}} & α < - \frac{1}{2} Λφ \neq π \\ \vert AB \vert \frac{α - \frac{1}{2}}{sin c ( φ )} & α \geq \frac{1}{2} Λφ \neq 0 \\ ∞ & otherwise\end{matrix} & ( 22 )\end{matrix}$$

$$\begin{matrix}[ Expression 27 ] & \\ l = \{ \begin{matrix}\frac{\vert AB \vert}{sin c \overline{( φ )}} & \vert α \vert \leq \frac{1}{2} Λφ \neq π \\ \vert AB \vert \frac{π ( \vert α \vert - \frac{1}{2} ) + \vert φ \vert}{\vert sin c ( φ ) \vert} & \vert α \vert > \frac{1}{2} Λφ \neq k π , k ∈ ℤ \\ ∞ & otherwise\end{matrix} & ( 23 )\end{matrix}$$

As described above, it is clear that |α|→∞ leads to l→∞. In the present embodiment as well, α=0 is selected because it is a local minimum value of the difference in curvature and does not correspond to a long path. This selection allows point J to be located again on the bisector of line segment AB. Moreover, Expressions (10) to (16) remain valid. In particular, if φ=φ_{A}=φ_{B}, these expressions are simplified as follows.

$$\begin{matrix}[ Expression 28 ] & \\ {J}_{α = 0} = M & ( 24 )\end{matrix}$$

$$\begin{matrix}[ Expression 29 ] & \\ {{\vert AJ \vert}_{α = 0} = \vert JB \vert}_{α = 0} = \frac{\vert AB \vert}{2} & ( 25 )\end{matrix}$$

$$\begin{matrix}[ Expression 30 ] & \\ {l}_{{A}_{α = 0}} = {l}_{{B}_{α = 0}} = \frac{\vert AB \vert}{2 sin c ( φ )} & ( 26 )\end{matrix}$$

$$\begin{matrix}[ Expression 31 ] & \\ {k}_{{A}_{α = 0}} = - \frac{4 sin ( φ )}{\vert AB \vert} & ( 27 )\end{matrix}$$

$$\begin{matrix}[ Expression 32 ] & \\ {k}_{{B}_{α = 0}} = \frac{4 sin ( φ )}{\vert AB \vert} & ( 28 )\end{matrix}$$

$$\begin{matrix}[ Expression 33 ] & \\ {k}_{{B}_{α = 0}} - {k}_{{A}_{α = 0}} = \frac{8 sin ( φ )}{\vert AB \vert} & ( 29 )\end{matrix}$$

### [Selection of J in Re-Planning]

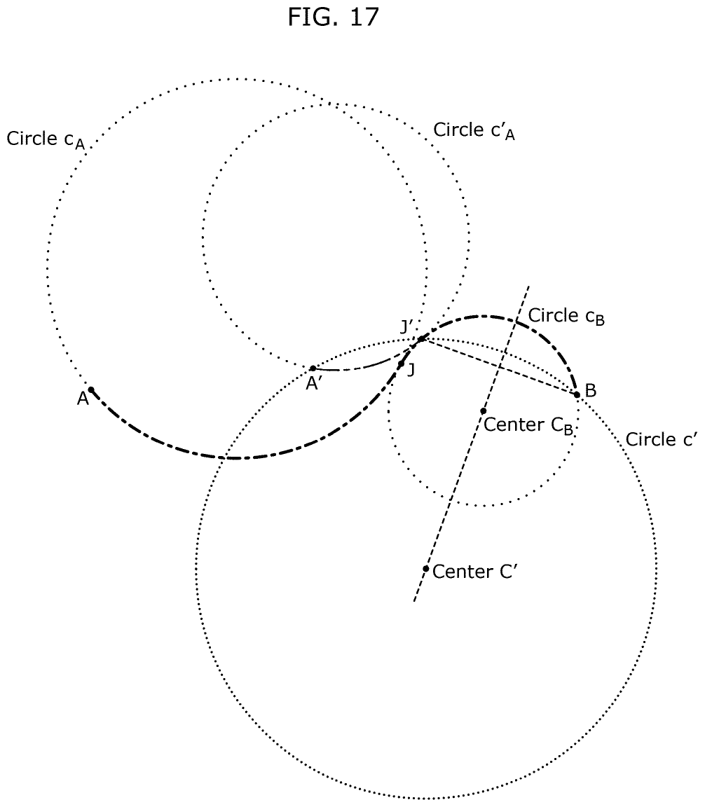

FIGS. 17 to 20 are diagrams for describing re-computation of the movement path of the mobile robot.

It is assumed that a movement path configured by a series of biarcs has been computed at time ti. It is also assumed that first biarc b is configured by two arcs AJ and JB. As the mobile robot moves along these arcs, pose (A, θ_{A}) at time ti changes to pose (B, OB).

The pose of the mobile robot at time tᵢ₊₁ is assumed to be (A′, θ′_{A}). Here, the movement path is supposed to be re-computed at time tᵢ₊₁. At this time, new biarc b′ from (A′, θ′_{A}) to (B, θ_{B}) is computed to become close to previous biarc b. Although it is possible to make the two arcs close to each other by computation using a conventional method from the perspective of a square distance, such a conventional method entails high computational cost (increases the amount of computation). In view of this, an heuristic shown in FIG. 17 is introduced.

Note that a circle that includes arc AJ is indicated by c_{A}. If arc AJ is a straight line (i.e., its curvature is zero), a line segment that includes arc AJ is indicated by using c_{A}. If c_{A} is a circle, the center of c_{A} is expressed as C_{A}. Similarly, a circle that includes arc BJ is indicated by c_{B}. If arc BJ is a straight line, a line segment that includes arc BJ is indicated by using c_{B}. If C_{B} is a circle, the center of c_{B} is expressed as C_{B}.

As a candidate for biarc b′ that is similar to biarc b, biarc b′ configured by arcs A′ and J′B is considered. Point J′ is selected such that point J′ is located on c_{B} and J′≠B is satisfied. In FIG. 17, biarc b (arc AJ+arc JB) is indicated by the dashed dotted line. Biarc b′ is configured by arc A′ indicated by the dashed double-dotted line and arc J′B that is part of original arc JB.

Here, c′ denotes the locus of points where point J′ can exist. From the above, if θ′_{A}≠θ_{B}+k2π, circle c′ is a circle that has center C′ defined by Expression (1) and that passes through point B. If θ′_{A}=θ_{B}+k2π, c′ is straight line A′B. Thus, in a similar biarc definition, point J′ needs to be at the point of intersection between c_{B} and c′. The two loci intersect with each other at least one point B. If both of c_{B} and c′ are circles and C′≠C_{B} is satisfied, point J′ is the reflection of point B about axis C_{B}C′ (i.e., a location symmetrical respect to the axis). The example shown in FIG. 17 corresponds to this case.

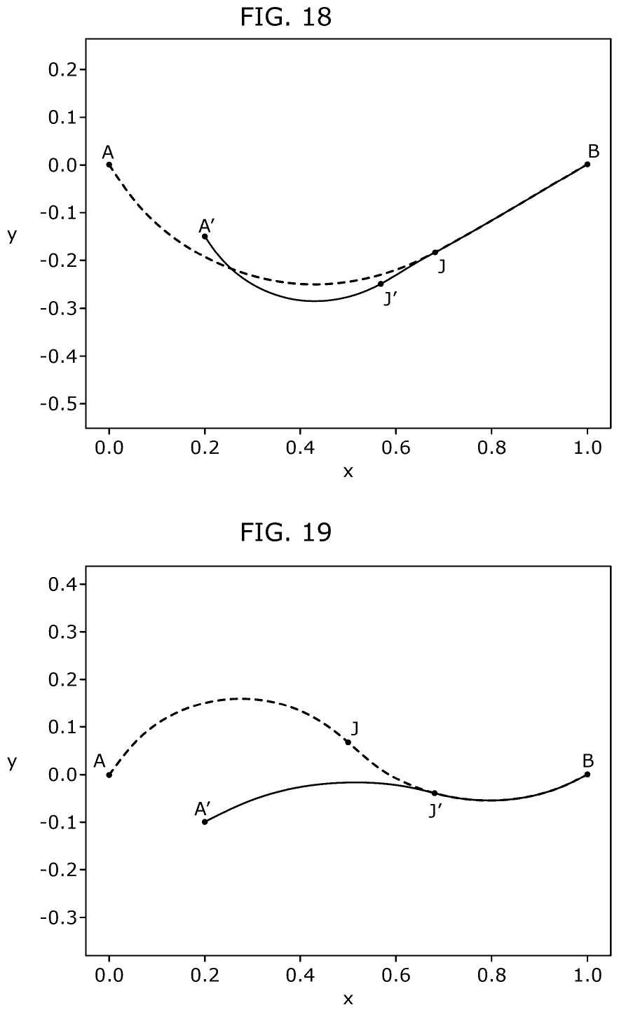

If c_{B} and c′ are circles and concentric, c_{B}=c′ is satisfied, and any point J′∈c′ is valid. In this case, point J′ corresponding to α=0 is selected. If c_{B} is a straight line and c′ is a circle, point J′ is the reflection of point B on an axis that is in a direction orthogonal to line segment JB and that passes through C′. This example is shown in FIG. 18.

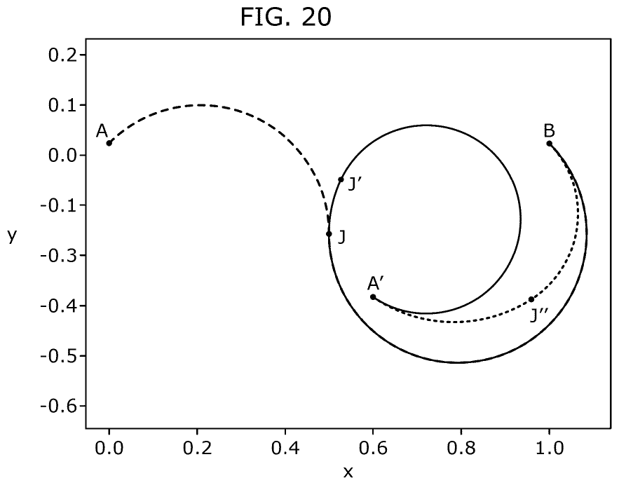

Similarly, if c_{B} is a circle and c′ is a straight line, point J′ is the reflection of point B on an axis that is in a direction orthogonal to line segment A′B and that passes through C_{B}. This example is shown in FIG. 19.

If c_{B} and c′ are both straight lines, there is no biarc b′ because point B is the only point of intersection.

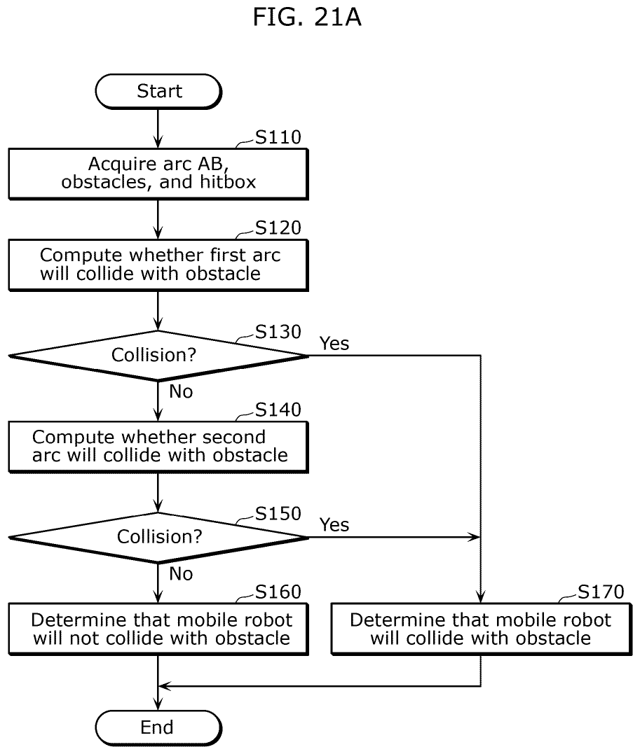

Selecting biarc b′ by using the heuristic described above normally provides excellent biarc b′ that overlaps with the second arc of the original biarc. However, in some cases, the obtained biarc may be fairly long or may include an arc with a considerably high curvature. This example is shown in FIG. 20. If biarc b=(arc AJ, arc JB) indicated by the broken line in FIG. 20 is used as a reference to compute a biarc from point A′ to point B, biarc b′=(arc A′J′, arc J′B indicated by the solid line is obtained. However, if the biarc is computed at α=0 from point A′ to point B (if a new biarc is computed by the same calculation method as in initial planning), it is possible to obtain more excellent biarc b″=(arc A′J′, arc J′B) indicated by the dotted line in FIG. 20.

Therefore, in re-planning, biarc b′ and biarc b″ are compared in length and difference in curvature. If γ≠k2π, the length of b″ may be computed using Expressions (12) and (13), and if γ=k2π, the length of b″ may be computed using Expression (26). If γ≠k2π, the difference in curvature of b″ may be computed using Expression (16), and if γ=k2π, the difference in curvature of b″ may be computed using Expression (29).

Accordingly, for example, if two parameters ηₗ>1 and ηₖ>1 are given, b″ may be selected, instead of b′, when l′>ηₗl″ or |k_{B}′−k_{A}′|>ηₖ|k_{B}″−k_{A}″|. As a result of the experiment, it has been confirmed that ηₗ=2 and nₖ=3 bring about excellent results.

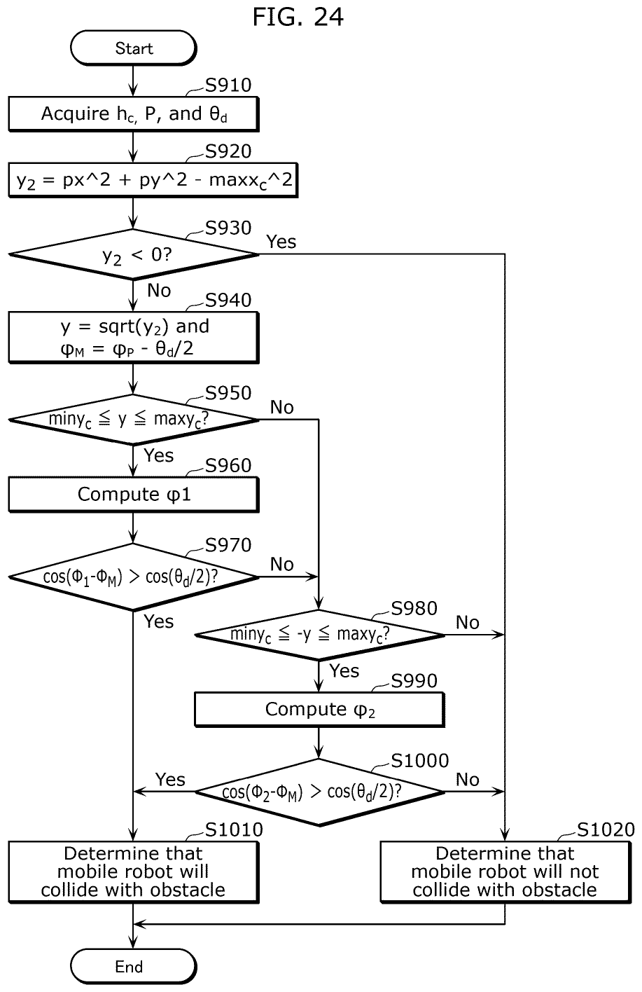

The computation of the movement path involving processing such as the selection and re-selection of J and the computation and re-computation of the biarc as described above is performed by, for example, calculation device 100 described later (see FIG. 25).

### [Collision Determination]

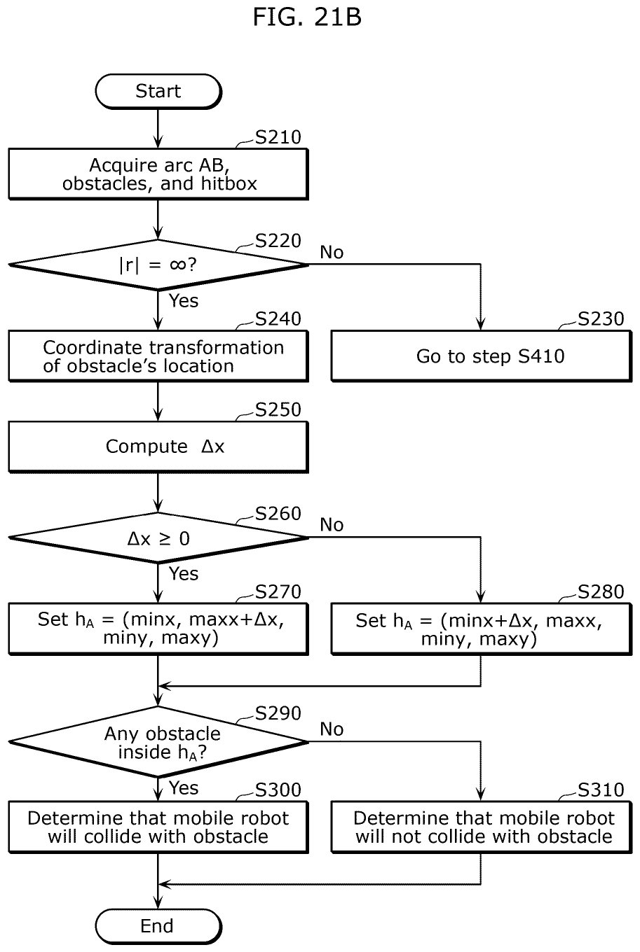

FIGS. 21A to 21C are flowcharts showing specific examples of processing for computing whether the mobile robot will collide with an obstacle. Specifically, FIGS. 21A, 21B, and 21C show flowcharts of checks performed on each biarc. The determination as to whether the computed movement path will collide with an obstacle can be checked by simply checking whether each arc configuring the movement path will collide with an obstacle.

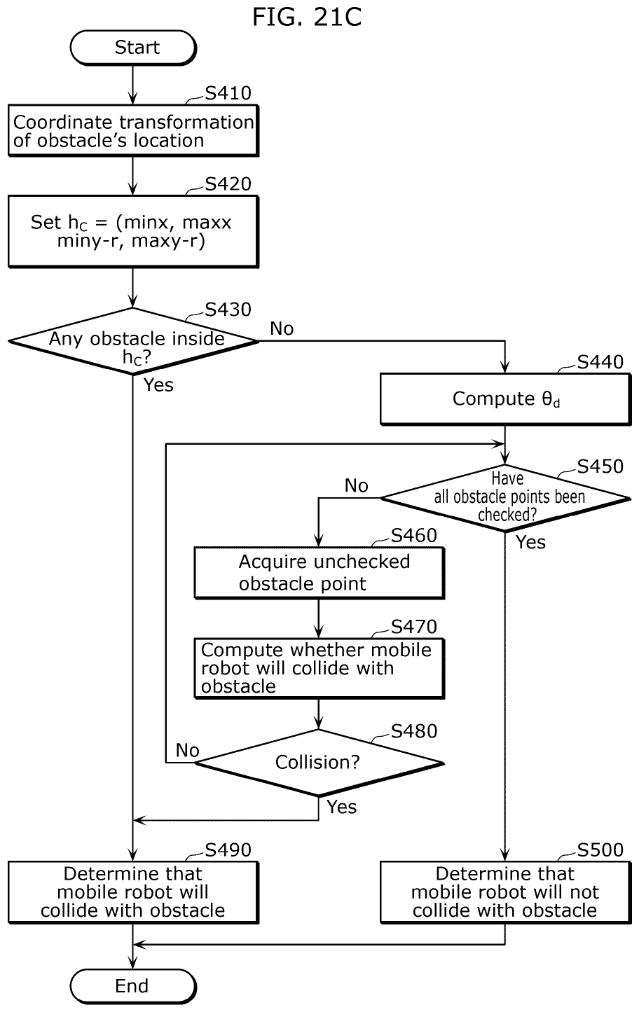

FIG. 22 is a flowchart showing a specific example of processing for computing whether the mobile robot will collide with an obstacle. Specifically, FIG. 22 shows a flowchart of checks performed on each arc.

Firstly, arcs, obstacles, and a hitbox are acquired as inputs.

The locations of the obstacles and the arcs (the movement path of the mobile robot) acquired here are assumed to be expressed in the global coordinate system (world coordinate system). Note that the arcs acquired here are information represented by initial location A, initial orientation θ_{A}, final location B, and final orientation θ_{B}. Locations A and B are expressed as follows.

$$\begin{matrix}[ Expression 34 ] & \\ A = [ \begin{matrix}{A}_{x} \\ {A}_{y}\end{matrix} ] & \end{matrix}$$

$$\begin{matrix}[ Expression 35 ] & \\ B = [ \begin{matrix}{B}_{x} \\ {B}_{y}\end{matrix} ] & \end{matrix}$$

The obstacles are assumed to be expressed as points. This normally applies to the case where obstacles are detected by using a LIDAR sensor. These are expressed by a matrix as follows.

$$\begin{matrix}[ Expression 36 ] & \\ {P}_{ω} = [ \begin{matrix}{P}_{ω , 1 , x} & {P}_{ω , 2 , x} & … & {P}_{ω , {N}_{0} , x} \\ {P}_{ω , 1 , y} & {P}_{ω , 2 , y} & … & {P}_{ω , {N}_{0} , y} \\ 1 & 1 & … & 1\end{matrix} ] & ( 30 )\end{matrix}$$

As shown in FIG. 3, a local coordinate system of the mobile robot (e.g., a new coordinate system fixed to the mobile robot and different from the world coordinate system as shown in FIG. 3) is considered, in which the origin point overlaps with the midpoint of two active wheels of the mobile robot, and the positive x-axial direction corresponds to the forward direction (movement direction) of the mobile robot. That is, the positive side of the x axis corresponds to the front of the mobile robot, and the positive side of the y axis corresponds to the left side of the mobile robot. Although the hitbox according to the present embodiment is assumed to have a rectangular shape whose sides are set along the axis described above, the hitbox may be generalized. That is, the hitbox can be set independently of the axis. The hitbox can be any polygon and does not necessarily have to be rectangular. No matter what shape the hitbox takes, the location of the hitbox is defined in the local coordinate system. The hitbox can be expressed as coordinates h=(minx, maxx, miny, maxy) of each vertex of the hitbox.

In the following computation, different computations are performed on an arc with an infinite radius of curvature (i.e., a straight line) and on an arc with a finite radius of curvature.

If the radius of curvature is infinite, obstacles are expressed in the local coordinate system of the mobile robot when the mobile robot has pose (A, θ_{A}). Here, the rotation matrix of angle θ is expressed as R(θ), and the matrix translated using vector v is expressed as T(v) as shown below.

$$\begin{matrix}[ Expression 37 ] & \\ R ( θ ) = [ \begin{matrix}cos ( θ ) & - sin ( θ ) & 0 \\ sin ( θ ) & cos ( θ ) & 0 \\ 0 & 0 & 1\end{matrix} ] & ( 31 )\end{matrix}$$

$$\begin{matrix}[ Expression 38 ] & \\ T ( v ) = [ \begin{matrix}1 & 0 & {v}_{x} \\ 0 & 1 & {v}_{y} \\ 0 & 0 & 1\end{matrix} ] & ( 32 )\end{matrix}$$

The locations of the obstacles in the local coordinate system are given by the following expression.

$$\begin{matrix}[ Expression 39 ] & \\ {P}_{l} = [ \begin{matrix}{P}_{l , 1 , x} & {P}_{l , 2 , x} & … & {P}_{l , {N}_{0} , x} \\ {P}_{l , 1 , y} & {P}_{l , 2 , y} & … & {P}_{l , {N}_{0} , y} \\ 1 & 1 & … & 1\end{matrix} ] = R ( - {θ}_{A} ) T ( - A ) {P}_{ω} & ( 33 )\end{matrix}$$

Also, x coordinate Δx of point B in the local coordinate system is defined as follows.

$$\begin{matrix}[ Expression 40 ] & \\ [ \begin{matrix}Δ x \\ 0 \\ 1\end{matrix} ] = R ( - {θ}_{A} ) T ( - A ) B & ( 34 )\end{matrix}$$

The hitbox placed at point A and expressed in the local coordinate system as described above, and new hitbox h_{A} corresponding to the convex closure of the hitbox placed at point B are defined. With respect to rectangular hitbox h defined in the above description, h_{A} becomes as follows.

$$\begin{matrix}[ Expression 41 ] & \\ \begin{matrix}{h}_{A} = ( {minx}_{A} , {maxx}_{A} , {miny}_{A} , {maxy}_{A} ) \\ = \{ \begin{matrix}( minx , maxx + Δ x , miny , maxy ) & if Δ x \geq 0 \\ ( minx + Δ x , maxx , miny , maxy ) & if Δ x < 0\end{matrix}\end{matrix} & ( 35 )\end{matrix}$$

Whether the mobile robot will collide with an obstacle can be determined by checking whether any point indicating an obstacle is inside h_{A}, i.e., by checking ∃i that satisfies minx_{A}≤p_{l,i,x}≤maxx_{A}∧miny_{A}≤p_{l,i,y}≤maxy_{A}, where 1≤i≤Nₒ.

If the arc has an infinite radius of curvature, different computation from that described above is performed. It is assumed that C is the rotation center of arc AB, and r is the signed radius of the arc. If |r|>0, the radius is positive when the arc rotates clockwise, and the radius is negative when the arc rotates counterclockwise. If the arc rotates in place, i.e., if A=B=C, r=0 is satisfied irrespective of the direction of rotation.

If points are expressed in the local coordinate system with origin point C and orientation θ_{A}, the following is given.

$$\begin{matrix}[ Expression 42 ] & \\ {P}_{C} = [ \begin{matrix}{P}_{C , 1 , x} & {P}_{C , 2 , x} & … & {P}_{C , {N}_{0} , x} \\ {P}_{C , 1 , y} & {P}_{C , 2 , y} & … & {P}_{C , {N}_{0} , y} \\ 1 & 1 & … & 1\end{matrix} ] = R ( - {θ}_{A} ) T ( - C ) {P}_{ω} & ( 36 )\end{matrix}$$

New hitbox h_{C} that corresponds to the hitbox expressed in such a local coordinate system is defined as follows.

$$\begin{matrix}[ Expression 43 ] & \\ \begin{matrix}{h}_{C} = ( {minx}_{C} , {maxx}_{C} , {miny}_{C} , {maxy}_{C} ) \\ = ( minx , maxx , miny - r , maxy - r )\end{matrix} & ( 37 )\end{matrix}$$

In order to check whether the mobile robot moving along the arc will collide with an obstacle, the following inference is drawn. For an obstacle to be inside the hitbox, either the obstacle is inside the hitbox from the beginning or the obstacle enters the hitbox while the mobile robot is moving.

The arc that is determined to collide with an obstacle is part of the movement path along which the mobile robot will move. Thus, if the mobile robot currently has pose (A, θ_{A}), it is physically impossible for any obstacle to be inside the mobile robot, but it is possible that an obstacle may enter the mobile robot that will move further along the movement path corresponding to the arc (specifically, the mobile robot with an initial pose on the biarc where the mobile robot will move).

In view of this, firstly, it is checked whether any obstacle is inside hitbox h_{C}. That is, it is checked whether ∃i satisfies minx_{C}≤p_{c,i,x}≤maxx_{C}∧miny_{C}≤p_{c,i,y}≤maxy_{C}, where 1≤i≤Nₒ. If there is any obstacle inside h_{C}, it is determined that the mobile robot will collide with the obstacle when the mobile robot moves along the computed movement path, and computation is terminated.

If there is no obstacles inside hitbox h_{C}, it is checked whether any obstacle enters hitbox h_{C} when the mobile robot moves along the computed movement path. In actuality, hitbox h_{C} is moving and obstacles remain at rest. However, computation becomes easier if it is considered that hitbox h_{C} remains at rest and obstacles are moving. Thus, in the following computation, whether the mobile robot will collide with an obstacle is determined assuming that obstacles are moving along the arc. In order for an obstacle to enter hitbox h_{C}, the obstacle needs to pass through one side of hitbox h_{C}. Therefore, whether the mobile robot will collide with an obstacle is determined by computing whether the trajectory of an obstacle that is assumed to move intersects with any side of hitbox h_{C}.

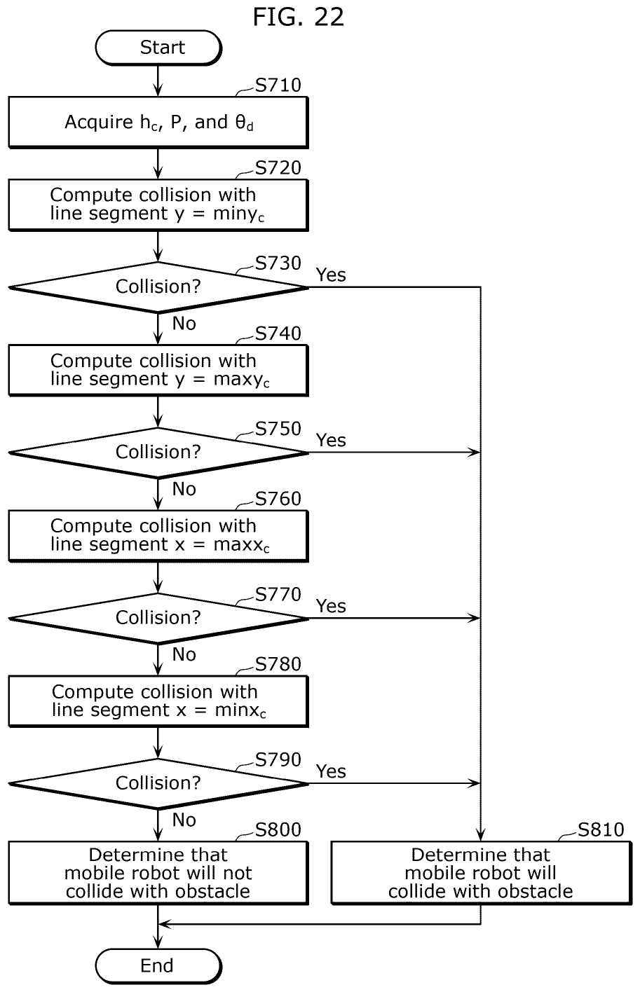

FIG. 23 is a diagram for describing a specific example of the processing for computing whether the mobile robot will collide with an obstacle.

The loci of obstacles are arcs because they correspond to the movement path of the mobile robot as described above. Specifically, the loci of obstacles have the same rotation center as rotation center C of the movement path of the mobile robot, and have an angle of the same size as and opposite in direction to angle θ_{d}=θ_{b}−θₐ of the movement path of the mobile robot. In the local coordinate system described above, the loci of all obstacles are on circles with the origin point as their center. Each side of hitbox h_{C} is aligned with the axis of the local coordinate system. Therefore, it is very easy to compute whether the mobile robot will collide with an obstacle.

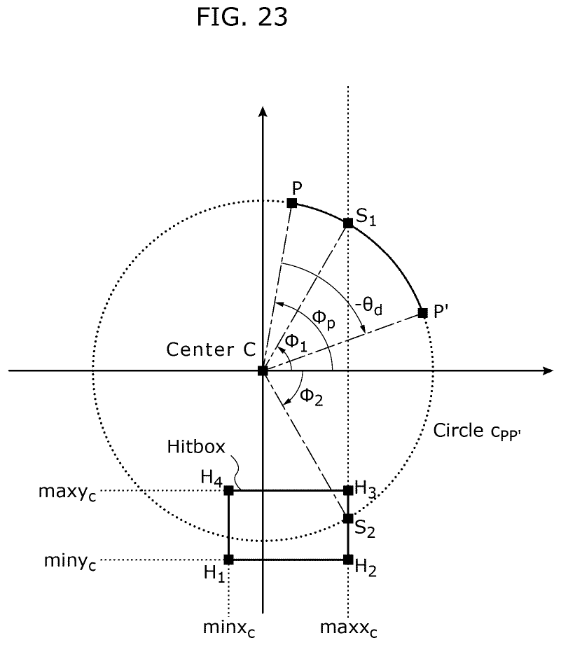

FIG. 24 is a flowchart showing a specific example of the processing for computing whether the mobile robot will collide with an obstacle.

It is assumed that point P is the location of an obstacle. Assuming that the obstacle moves from point P to point P′, arc PP′ can be expressed by using angle −θ_{d}. A circle that includes arc PP′ is defined as c_{PP′}. Then, it is determined whether arc PP′ intersects with side H₂H₃.

Note that points P, H₂, and H₃ are expressed as follows.

$$\begin{matrix}[ Expression 44 ] & \\ P = [ \begin{matrix}{P}_{c , i , x} \\ {P}_{c , i , y}\end{matrix} ] & \end{matrix}$$

$$\begin{matrix}[ Expression 45 ] & \\ {H}_{2} = [ \begin{matrix}{maxx}_{c} \\ {miny}_{c}\end{matrix} ] & \end{matrix}$$

$$\begin{matrix}[ Expression 46 ] & \\ {H}_{3} = [ \begin{matrix}{maxx}_{c} \\ {maxy}_{c}\end{matrix} ] & \end{matrix}$$

In order to determine whether arc PP′ intersects with side H₂H₃, firstly, a point of intersection between side H₂H₃ and circle c_{PP′} is computed as follows.

$$\begin{matrix}[ Expression 47 ] & \\ {y}_{2} = {p}_{c , i , x}^{2} + {p}_{c , i , y}^{2} - m a x {x}_{C}^{2} & ( 38 )\end{matrix}$$

If y₂<0, there is no point of intersection between circle c_{PP′} and side H₂H₃, and therefore there is also no point of intersection between arc PP′ and side H₂H₃. On the other hand, if y₂>0, there are two points of intersection between circle c_{PP′} and side H₂H₃.

Assuming that γ=√y2 and these two points of intersection are expressed as points P1 and P2, the following expressions are computed.

$$\begin{matrix}[ Expression 48 ] & \\ {S}_{1} = [ \begin{matrix}{maxx}_{c} \\ y\end{matrix} ] & ( 39 )\end{matrix}$$

$$\begin{matrix}[ Expression 49 ] & \\ {S}_{2} = [ \begin{matrix}{maxx}_{c} \\ - y\end{matrix} ] & ( 40 )\end{matrix}$$

In this way, S₁=S₂ is satisfied if y₂=0 (i.e., if side H₂H₃ is in contact with circle c_{PP′}).

Here, the angle formed by line segment CP and x axis is assumed to be Φₚ. Similarly, the angle formed by the x axis and line segment CS₁ and the angle formed by the x axis and line segment CS₂ are expressed as Φ₁ and Φ₂, respectively. In this case, angle Φ_{M} at the midpoint of arc PP′ becomes as follows.

$$\begin{matrix}[ Expression 50 ] & \\ {φ}_{M} = {φ}_{P} - \frac{{θ}_{d}}{2} & ( 41 )\end{matrix}$$

As a result, each of points S₁ and S₂ is located at the point of intersection between arc PP′ and side H₂H₃ only when the point is located on both of arc PP′ and side H₂H₃. S₁∈H₂H₃ is satisfied only when miny_{C}<y<maxy_{C}. S₁ is located on arc PP′ only when cos(Φ₁−Φ_{M})>cos(Φ_{d}/2) is satisfied.

Similarly, S₂∈H₂H₃ is satisfied only when miny_{C}<−y<maxy_{C}, and S₁∈arcPP′ is satisfied only when cos(Φ₂−Φ_{M})>cos(Φ_{d}/2). In this way, collision between the arc and each side of the hitbox can be determined efficiently without sampling as shown in FIG. 4.

FIGS. 23 and 24 show examples of the cases where it is computed whether side H₂H₃ will collide with an obstacle. Collision between an obstacle and the other sides of the hitbox can also be determined in the same manner as in the computation performed for side H₂H₃.

For example, calculation device 100 described below (see FIG. 25) performs processing shown in FIGS. 21A to 24.

FIG. 21A is a flowchart showing an overview of collision determination.

Firstly, calculation device 100 acquires arcs AB (i.e., a movement path), obstacles (specifically, the locations and shapes of obstacles), and a hitbox (specifically, coordinates of a hitbox) (S110).

Then, calculation device 100 computes whether a first arc (an arc that includes point A as its end point out of two arcs of arc AB; specifically, arc AJ) will collide with any of the obstacles (S120). For example, whether the first arc will collide with any of the obstacles is computed as described above with reference to FIG. 23.

In the case where it is determined that the first arc will not collide with any of the obstacles (No in S130), calculation device 100 computes whether a second arc (an arc that includes point B as its end point out of the two arcs of arc AB; specifically, arc JB) will collide with any of the obstacles (S140). For example, whether the second arc will collide with any of the obstacles is computed as described above with reference to FIG. 23.

In the case where it is determined that the second arc will not collide with any of the obstacles (No in S150), calculation device 100 determines that the mobile robot will not collide with any of the obstacles even if moving along the movement path (S160).

On the other hand, in the case where it is determined that the first arc will collide with any of the obstacles (Yes in S130) or where it is determined that the second arc will collide with any of the obstacles (Yes in S150), calculation device 100 determines that the mobile robot will collide with any of the obstacles if moving along the movement path (S170).

FIGS. 21B and 21C are flowcharts showing a specific example of collision determination using a hitbox.

Firstly, calculation device 100 acquires arc AB, obstacles, and a hitbox as in step S110 (S210).

Then, calculation device 100 determines whether |r|=∞ is satisfied (S220).

In the case where it is determined that |r|=∞ is satisfied (Yes in S220), calculation device 100 transforms the coordinates of the obstacles by using R(−θ_{A})T(−A)B (S240).

Then, calculation device 100 computes Δx as the x coordinate of R(−θ_{A})T(−A)B (S250).

Then, calculation device 100 determines whether Δx≥0 is satisfied (S260).

In the case where it is determined that Δx≥0 is satisfied (Yes in S260), calculation device 100 sets the hitbox to h_{A}=(minx, maxx+Δx, miny, maxy) (S270).

On the other hand, in the case where it is determined that Δx>0 is not satisfied (No in S260), calculation device 100 sets the hitbox to h_{A}=(minx+Δx, maxx, miny, maxy) (S280).

Subsequent to step S270 or S280, calculation device 100 determines whether any of the obstacles is inside set hitbox h_{A} (S290).

In the case where it is determined that any of the obstacles is inside set hitbox h_{A} (Yes in S290), calculation device 100 determines that the mobile robot will collide with the obstacle if moving along the movement path (S300).

On the other hand, in the case where it is determined that no obstacles are inside set hitbox h_{A} (No in S290), calculation device 100 determines that the mobile robot will not collide with any of the obstacles even if moving along the movement path (S310).

In the case where it is determined that |r|=∞ is not satisfied (No in S220), calculation device 100 moves the processing to step S410 shown in FIG. 21C (S230).

In the case of No in step S220, calculation device 100 transforms the coordinates of the obstacles by using R(−θ_{A})T(−C) (S410).

Then, calculation device 100 sets the hitbox to h_{C}=(minx, maxx, miny−r, maxy−r) (S420).

Then, calculation device 100 determines whether any of the obstacles is inside set hitbox h_{C} (S430).

In the case where it is determined that no obstacles are inside set hitbox h_{C} (No in S430), calculation device 100 computes θ_{d} ((ΦB−ΦA)) (S440).

Then, calculation device 100 determines whether the points of all of the obstacles have been checked (collision determination) (S450). For example, in subsequent steps S460 to S480, calculation device 100 performs collision determination on each point of the obstacles acquired by a LIDAR.

In the case where it is determined that there is an unchecked point (No in S450), calculation device 100 acquires the unchecked point of an obstacle (specifically, information indicating the location of the point) (S460).

Calculation device 100 determines whether the acquired point will collide with each side of hitbox h_{C} (S470).

In the case where it is determined that the acquired point will not collide with each side of hitbox h_{C} (No in S480), calculation device 100 returns the processing to step S450.

In the case where it is determined that any of the obstacles is inside set hitbox h_{C} (Yes in S430) or where it is determined that the acquired point will collide with any side of hitbox h_{C} (Yes in S480), calculation device 100 determines that the mobile robot will collide with an obstacle if moving along the movement path (S490).

On the other hand, in the case where it is determined that the points of all of the obstacles have already been checked (Yes in S450), calculation device 100 determines that the mobile robot will not collide with any of the obstacles even if moving along the movement path (S500).

FIG. 22 is a flowchart showing a specific example of step S480 shown in FIG. 21C.

Firstly, calculation device 100 acquires hitbox h_{C}, point P of an obstacle, and θ_{d} (S710).

Then, calculation device 100 determines whether γ=miny_{C} (range:(minx_{C}, maxx_{C})) is satisfied, i.e., whether point P will collide with line segment H₁H₂(S720).

In the case where it is determined that point P will not collide with line segment H₁H₂(No in S730), calculation device 100 determines whether γ=maxy_{c} (range:(minx_{C}, maxx_{C})) is satisfied, i.e., whether point P will collide with line segment H₃H₄(S740).

In the case where it is determined that point P will not collide with line segment H₃H₄(No in S750), calculation device 100 determines whether x=maxx_{c} (range:(miny_{C}, maxy_{C})) is satisfied, i.e., whether point P will collide with line segment H₂H₃(S760).

In the case where it is determined that point P will not collide with line segment H₂H₃(No in S770), calculation device 100 determines whether x=minx_{c} (range:(miny_{C}, maxy_{C})) is satisfied, i.e., whether point P will collide with line segment H₁H₄(S780).

In the case where it is determined that point P will not collide with line segment H₁H₄(No in S790), calculation device 100 determines that the mobile robot will not collide with the obstacle even if moving along the movement path (S800).

On the other hand, in the case where it is determined that point P will collide with line segment H₁H₂(Yes in S730), where it is determined that point P will collide with line segment H₃H₄(Yes in S750), where it is determined that point P will collide with line segment H₂H₄(Yes in S770), or where it is determined that point P will collide with line segment H₁H₄(Yes in S790), calculation device 100 determines that the mobile robot will collide with the obstacle if moving along the movement path (S810).

FIG. 24 is a flowchart showing a specific example of processing for determining whether point P of an obstacle will collide with each side of the hitbox as in the processing of step S760 shown in FIG. 22.

Firstly, calculation device 100 acquires hitbox h_{C}, point P of the obstacle, and θ_{d} (S910).

Then, calculation device 100 computes y₂ (=px²+py²−maxx_{C}²) (S920). Here, px is the x coordinate of point P, and py is the y coordinate of point P.

Then, calculation device 100 determines whether y₂<0 is satisfied (S930).

In the case where it is determined that y₂<0 is not satisfied (No in S930), calculation device 100 computes y (ζ=sqrt(y₂)) and Φ_{M} (=Φₚ−θ_{d}/2) (S940).

Then, calculation device 100 determines whether miny_{C}≤y≤maxy_{C} is satisfied (S950).

In the case where it is determined that miny_{C}≤y≤maxy_{C} is satisfied (Yes in S950), calculation device 100 computes Φ₁ (S960).

Then, calculation device 100 determines whether cos(Φ1−Φ_{M})>cos(θ_{d}/2) is satisfied (S970).

In the case where it is determined that cos(Φ₁−Φ_{M})>cos(θ_{d}/2) is not satisfied (No in S970), calculation device 100 determines whether miny_{C}≤−y≤maxy_{C} is satisfied (S980).

In the case where it is determined that miny_{C}≤−y≤maxy_{C} is satisfied (Yes in S980), calculation device 100 computes Φ₂ (S990).

Then, calculation device 100 determines whether cos(Φ₂−Φ_{M})>cos(θ_{d}/2) is satisfied (S1000).

In the case where it is determined that cos(Φ₁−Φ_{M})>cos(θ_{d}/2) is satisfied (Yes in S970) or where it is determined that cos(Φ₂−Φ_{M})>cos(θ_{d}/2) is satisfied (Yes in S1000), calculation device 100 determines that the mobile robot will collide with the obstacle if moving along the movement path (S1010).

On the other hand, in the case where it is determined that y₂<0 is satisfied (Yes in S930), where it is determined that miny_{C}≤−y≤maxy_{C} is not satisfied (No in S980), or where it is determined that cos(Φ₂−Φ_{M})>cos(θ_{d}/2) is not satisfied (No in S1000), calculation device 100 determines that the mobile robot will not collide with the obstacle even if moving along the movement path (S1020).

### CONCLUSION

### Configuration

FIG. 25 is a block diagram showing a configuration of mobile robot 10 according to the embodiment.

Mobile robot 10 is an autonomous mobile body. For example, mobile robot 10 may be a mobile body that executes tasks such as clean-up, sweeping, or data collection while moving along a movement path computed as described by using simultaneous localization and mapping (SLAM) technology. For example, mobile robot 10 may detect information indicating the locations of substances such as walls and objects located around mobile robot 10 by using a sensor such as a LIDAR, and estimate its own location by using the detected information and a map of a region where mobile robot 10 moves. For example, mobile robot 10 may estimate its own location by using odometry information. For example, mobile robot 10 may move (travel) from its own location to a predetermined destination along the computed movement path.

Mobile robot 10 includes detector 20, controller 30, actuator 40, and calculation device 100.

Detector 20 is a sensor that detects surrounding environments or the like of mobile robot 10 in order to allow autonomous movement of mobile robot 10. Detector 20 may include, for example, a camera that detects, for example, road surfaces or surrounding environments of mobile robot 10, an angular velocity sensor that detects the orientation of mobile robot 10 (e.g., the movement direction of mobile robot 10), and an odometry sensor that measures the number of revolutions of wheels of mobile robot 10 (odometry information).

Controller 30 is a processing unit that controls each device included in mobile robot 10. For example, controller 30 causes mobile robot 10 to move along a movement path computed by calculation device 100. For example, controller 30 may cause mobile robot 10 to move by controlling actuator 40. Specifically, controller 30 controls actuator 40 based on its own estimated location such that mobile robot 10 moves along the movement path computed by calculation device 100. For example, based on the detection result obtained from detector 20, controller 30 generates a map (map information) of a predetermined space where robot 10 moves by using the SLAM technology described above, or computes (estimates) the location of mobile robot 10 in the predetermined space (more specifically, the coordinates in the map of the predetermined space).

For example, controller 30 may be realized by a control program for executing the processing described above, memory that stores a variety of information such as the control program and the map, and a processor such as a central processing unit (CPU) that executes the control program.

Actuator 40 is a device that causes mobile robot 10 to move. Actuator 40 may include, for example, a drive motor for rotating the wheels.

Calculation device 100 is a processing device that performs the above-described processing such as the computation of the movement path of mobile robot 10 and the determination of whether mobile robot 10 will collide with an obstacle. For example, calculation device 100 is a computer that is realized by, for example, a communication interface for communication with devices such as detector 20 and controller 30, nonvolatile memory that stores programs, volatile memory that serves as a temporal storage area for executing the programs, input/output ports for transmitting and receiving signals, and a processor that executes the programs. The communication interface may be realized as a connector connected to a communication line for cable communication or the like, or may be realized as a wireless communication circuit or the like for wireless communication. There are no particular limitations on the communication standards adopted for the communication.

Note that calculation device 100 may be mounted on mobile robot 10, or may be provided as a server device or the like, separately from mobile robot 10.

Calculation device 100 includes acquirer 110, calculator 120, outputter 130, and storage 140.

Acquirer 110 is a processing unit that acquires a variety of information. For example, acquirer 110 acquires a variety of information from detector 20 and storage 140. For example, acquirer 110 may acquire information from an external server device or the like via a communication interface.

For example, acquirer 110 may acquire a first location and a second location different from the first location. The first location may, for example, be location A shown in FIGS. 8A to 8D, and the second location may be location B shown in FIGS. 8A to 8D. Specifically, acquirer 110 acquires lattice information that indicates a plurality of lattice points each indicating a location of mobile robot 10 and the orientation of mobile robot 10 at the location.

The lattice information may, for example, be the lattice described above. For example, the lattice points each indicate a location where the user wants mobile robot 10 to move and the orientation of mobile robot 10 at the location. The lattice points may, for example, be the waypoints shown in FIG. 6. For example, the current location of mobile robot 10 may be the first location, and the first point may be the second location. Alternatively, for example, the first point may be the first location, and the second point may be the second location. For example, acquirer 110 acquires a plurality of first waypoints and numerical information, the first waypoints each indicating a location of mobile robot 10 and an orientation of mobile robot 10 at the location. Moreover, for example, acquirer 110 acquires lattice information by increasing a plurality of second waypoints by a number corresponding to the numerical value indicated by the numerical information, the second waypoints being different in location from the first waypoints, and generating the lattice information in which the first and second waypoints are used as the lattice points.

The first waypoints may, for example, be the waypoints that indicate the predetermined locations and orientations shown in FIG. 6. The second waypoints may be waypoints that indicate the locations and orientations that are added when n=2 shown in FIG. 6. The numerical information may indicate, for example, a value indicating n (in the above-described example, n=2). For example, the numerical information may indicate a value that is arbitrarily set by a user. That is, n may be zero, one, or three or more.

Calculator 120 is a processing unit that performs the computation of the movement path of mobile robot 10 and the determination of whether mobile robot 10 will collide with an obstacle. Specifically, calculation device 100 includes calculator 120 that computes a first movement path of mobile robot 10 that moves autonomously from the first location to the second location. Calculator 120 computes the movement path (first movement path) so as to connect the first and second locations by a biarc.

The biarc refers to a line that connects two arcs. For example, as shown in FIG. 8C or 8D, the biarc may be such that at least one of the two arcs included in the biarc has a curvature of zero (i.e., the arc is a straight line), or the two arcs may overlap each other (i.e., the two arcs form one arc).

Computing the movement path to connect the two arcs by the biarc means, for example, computing the movement path by using an expression for computing continuous (in other words, a series of) two arcs having G₁ continuity. For example, a straight line may be computed when any arc has an infinite radius of curvature in the above expression. Alternatively, for example, one arc may be computed when the centers of the two arcs are set at the same location in the above expression. Therefore, using the expression for computing the arcs, calculator 120 computes, as the movement path, two lines that connect the first and second locations and that have G₁ continuity (e.g., two arcs configuring a biarc). Here, calculator 120 computes the two lines such that the first location overlaps with one end of a first line out of the two lines, the other end of the first line overlaps with one end of a second line out of the two lines, and the other end of the second line overlaps with the second location. Calculator 120 also computes the movement path such that the movement path has G₁ continuity, i.e., the movement path has G₁ continuity on the first line, on the second line, and at the joint point at which the other end of the first line overlaps with one end of the second line. In other words, calculator 120 computes the first movement path of mobile robot 10 that moves autonomously from the first location to the second location by using a predetermined line consisting of two continuous lines (specifically, a biarc). Specifically, calculator 120 computes the two lines by using an expression for computing an arc so that one ends of the two lines are connected to each other at the joint point, and the first movement path is computed so as to connect the first and second locations by a predetermined line.

For example, in the case of computing the movement path, calculator 120 locates the joint point on the bisector of a line segment that connects the first and second locations, the joint point being a location where the two arcs of the biarc indicating the movement path are joined together. Furthermore, for example, when (i) φ_{B}>φ_{A}, calculator 120 locates the joint point to the right of the second location, as viewed from the first location; when (ii) φ_{B}<φ_{A}, calculator 120 locates the joint point to the left of the second location, as viewed from the first location; and when (iii) φ_{B}=φ_{A}, calculator 120 locates the joint point on the line segment that connects the first and second locations, where φ_{A} (−π≤φ_{A}≤π) is the angle indicating the orientation of mobile robot 10 at the first location with respect to a reference line, and φ_{B}(−π≤φ_{B}≤π) is the angle indicating the orientation of mobile robot 10 at the second location with respect to the reference line.

The joint point may, for example, be point J described above. The reference line may, for example, line segment AB.

Note that the reference line may be set arbitrarily.

In this way, for example, calculator 120 computes the movement path from the first location (e.g., the current location of mobile robot 10) to the second location. For example, calculator 120 also computes the movement path based on the lattice information so as to connect the current location of mobile robot 10 and a first point by a biarc, the first point being one of the lattice points, and to connect the first point and a second point by a biarc, the second point being one of the lattice points other than the first point.

As described above, calculator 120 generates the movement path (initial movement path) by, for example, connecting the current location of mobile robot 10 and each waypoint by a biarc so that the mobile robot is oriented in a direction specified by each waypoint.

For example, controller 30 may cause mobile robot 10 to move along the movement path computed by calculator 120.

Here, for example, a case is assumed in which, after having started moving from the first location, mobile robot 10 is moved to a third location by a user or the like. In such a case, calculator 120 re-computes the movement path. Specifically, calculator 120 computes a movement path from the third location to the second location. For example, in the case where a movement path (second movement path) of mobile robot 10 that moves autonomously from the third location, which is different from the first and second locations, to the second location is computed after computation of the first movement path, calculator 120 computes the second movement path based on the first movement path so that the second and third locations are connected by a biarc. Specifically, it is assumed that the location where the two arcs of the biarc indicating the first movement path are joined together is defined as a first joint point, and the location where two arcs of the biarc indicating the second movement path are joined together is defined as a second joint point. Then, in the case of computing the second movement path, if a first arc that connects the second joint point and the second location has a finite radius of curvature, the first arc being one of the two arcs of the biarc indicating the second movement path, calculator 120 locates the second joint point on a circle of a second arc that connects the first joint point and the second location, the second arc being one of the two arcs of the biarc indicating the first movement path. Moreover, for example, if the first arc has an infinite radius of curvature, calculator 120 locates the second joint point on a straight line that passes through the first joint point and the second location. The third location may, for example, be location A′ shown in FIGS. 17 to 19.

The first joint point may, for example, be point J. The second joint point may, for example, be point J shown in FIGS. 17 to 19. If the first arc has a finite radius of curvature, for example, the first arc is circular as shown in FIG. 19 and set to overlap with at least part of the second arc. On the other hand, if the first arc has an infinite radius of curvature, the first arc becomes a straight line as shown in FIG. 18. If the first arc has an infinite radius of curvature, calculator 120 locates the second joint point on a straight line that is an extension of the first arc that is a straight line.

In this way, for example, in the case of re-computing the movement path, calculator 120 computes a new movement path depending on the original movement path (specifically, to overlap in part with the original movement path).

In the case of re-computing the movement path, for example, calculator 120 may compute a new movement path without considering the original movement path. Alternatively, in the case of re-computing the movement path, calculator 120 may compute the movement path depending on the original movement path and also compute the movement path without considering the original movement path, and then compare these two computed movement paths to determine a better one as the new movement path.

Superficially, for example, calculator 120 computes a movement path (third movement path) so as to connect the second and third locations by a biarc. In the case of computing the third movement path, calculator 120 locates a third joint point on the bisector of a line segment that connects the third and second locations, the third joint point being a location where two arcs of the biarc indicating the third movement path are joined together.

Furthermore, (iv) if φ_{B}>φ_{C}, calculator 120 locates the third joint point to the right of the second location, as viewed from the third location; (v) if φ_{B}<φ_{C}, calculator 120 locates the third joint point to the left of the second location, as viewed from the third location; and (vi) if φ_{B}=φ_{C}, calculator 120 locate the third joint point on the line segment that connects the third and second locations, where φ_{C} (−π≤φ_{C}≤π) is the angle indicating the orientation of mobile robot 10 at the third location with respect to a reference line, and φ_{B} (−π≤φ_{B}≤π) is the angle indicating the orientation of mobile robot 10 at the second location with respect to the reference line. Moreover, for example, calculator 120 compares the second movement path (the first new movement path) and the third movement path (the second new movement path), and determines the second movement path as the movement path of mobile robot 10 that moves autonomously from the third location to the second location when (vii) the length of the second movement path is shorter than the length of the third movement path that is multiplied by a first coefficient and (viii) an absolute value of a difference in curvature between the two arcs of the biarc indicating the second movement path is smaller than a value obtained by multiplying an absolute value of the difference in curvature between the two arcs of the biarc indicating the third movement path by a second coefficient.

The third joint point may, for example, be J″ shown in FIG. 20. For example, calculator 120 compares the movement path indicated by the solid line in FIG. 20 (one example of the second movement path; arc A′B indicated by the solid line) and the movement path indicated by the dotted line in FIG. 20 (one example of the third movement path; arc A′B indicated by the dotted line) and determines the one with a shorter distance as the new movement path.

The first and second coefficients are each a numerical value greater than or equal to one and are arbitrarily set by a user.

For example, the first and second coefficients may be stored in advance in storage 140.

Outputter 130 is a processing unit that outputs the computation result obtained from calculator 120. For example, outputter 130 outputs the computation result including the movement path computed by calculator 120 and the result of collision determination to controller 30.

Each processing unit such as acquirer 110, calculator 120, and outputter 130 is realized by a control program for executing the processing described above, memory that stores the control program, and a processor such as a CPU that executes the control program.

Storage 140 is a storage device that stores control programs executed by each processing unit such as acquirer 110, calculator 120, and outputter 130. For example, storage 140 may be realized by a hard disk drive (HDD) and/or flash memory.

### Processing Procedure

Next, a processing procedure performed by mobile robot 10 will be described.

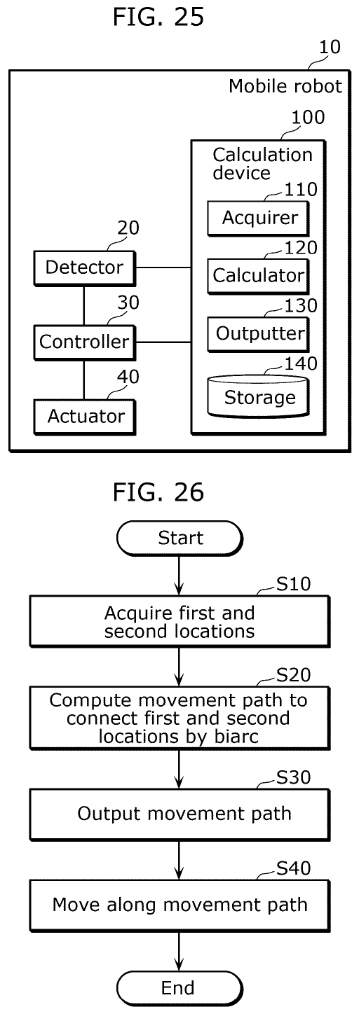

FIG. 26 is a flowchart showing the processing procedure performed by mobile robot 10 according to the embodiment.

Acquirer 110 acquires the first location and the second location different from the first location (S10). For example, acquirer 110 acquires lattice information that indicates the first and second locations stored in storage 140. For example, acquirer 110 may acquire information indicating the first and second locations from an external server or the like via a communication interface included in calculation device 100. Alternatively, for example, in the case where calculation device 100 is realized as a server device or the like separately from mobile robot 10, acquirer 110 may acquire the first and second locations from mobile robot 10.

Then, calculator 120 computes the first movement path of mobile robot 10 that moves autonomously from the first location to the second location (S20). Here, calculator 120 computes the movement path (first movement path) so as to connect the first and second locations by a biarc.

Then, outputter 130 outputs the movement path (specifically, information indicating the movement path) computed by calculator 120 (S30). For example, outputter 130 may output the movement path to controller 30.

Then, controller 30 causes mobile robot 10 to move (travel) based on the movement path (S40). Specifically, controller 30 causes mobile robot 10 to move along the movement path.

### Advantageous Effects

Hereinafter, examples of the techniques obtained from the disclosures described in the specification of the present disclosure are shown, and advantageous effects or the like achieved by these techniques are described.

Technique 1 is calculation device 100 that includes acquirer 110 that acquires a first location and a second location different from the first location, and calculator 120 that computes a first movement path of mobile robot 10 that moves autonomously from the first location to the second location. Calculator 120 computes the first movement path to connect the first location and the second location by a biarc.

This reduces throughput in autonomous movement of mobile robot 10. Specifically, since the movement path of mobile robot 10 is a combination of arcs, as described above, the computation of determining whether mobile robot 10 (more specifically, the hitbox described above) will collide with an obstacle becomes easier than the computation of collision determination performed by repeatedly setting a hitbox as in conventional cases. Accordingly, calculation device 100 is capable of reducing throughput in autonomous movement of mobile robot 10. Since the movement path of mobile robot 10 is a combination of arcs, it is possible to compute the movement path with G₁ continuity, unlike the movement path computed by a combination of only straight lines. This enables the computation of the movement path that allows the mobile robot to easily continue moving without stopping in order to change its orientation.

Technique 2 is calculation device 100 according to Technique 1, in which in the case of computing the first movement path, calculator 120 locates a joint point on a bisector of a line segment that connects the first location and the second location, the joint point being a location where two arcs of a biarc indicating the first movement path are joined together. Moreover, (i) if φ_{B}>φ_{A}, calculator 120 locates the joint point to the right of the second location, as viewed from the first location; (ii) if φ_{B}<φ_{A}, calculator 120 locates the joint point to the left of the second location, as viewed from the first location; and (iii) if φ_{B}=φ_{A}, calculator 120 locates the joint point on the line segment that connects the first location and the second location, where φ_{A} (−π≤φ_{A}≤π) is the angle indicating the orientation of mobile robot 10 at the first location with respect to a reference line, and φ_{B} (−π≤φ_{B}≤π) is the angle indicating the orientation of mobile robot 10 at the second location with respect to the reference line.

The joint point may, for example, be point J described above. As described above, the presence of point J, i.e., the joint point, on the bisector of line segment AB means that α=0 is satisfied. If α=0, it is possible to reduce the difference in curvature between the two arcs of the biarc and to shorten the length of the movement path.

Technique 3 is calculation device 100 according to Technique 1 or 2, in which acquirer 110 acquires lattice information that indicates a plurality of lattice points, each indicating a location and an orientation of mobile robot 10 at the location, and calculator 120 computes the first movement path based on the lattice information to connect the current location of mobile robot 10 with a first point that is one of the lattice points by a biarc and connect the first point with a second point that is one of the lattice points other than the first point by a biarc.

In this way, calculator 120 computes the movement path of mobile robot 10 by selecting the current location of mobile robot 10 and two lattice points from among the lattice points and repeating computation to connect one of the two points serving as a first location and the other point serving as a second location by a biarc.

This allows calculator 120 to easily compute the movement path by using the lattice points.

Technique 4 is calculation device 100 according to Technique 3, in which acquirer 110 acquires lattice information by acquiring a plurality of first waypoints and numerical information, the first waypoints each indicating a location of the mobile robot and an orientation of the mobile robot at the location, increasing a plurality of second way points by a number corresponding to a numerical value indicated by the numerical information, the second waypoints being different in location from the first waypoints; and generating the lattice information in which the first and second waypoints are used as the lattice points.

Accordingly, for example, since the numerical information is set depending on the size of a space that mobile robot 10 moves, calculator 120 can appropriately select waypoints and compute the movement path so as to avoid obstacles even if the obstacles are located in unexpected places.

Technique 5 is calculation device 100 according to any one of Techniques 1 to 4, in which in the case where the second movement path of mobile robot 10 that moves autonomously from a third location different from the first and second locations to the second location is computed after the computation of the first movement path, calculator 120 computes the second movement path based on the first movement path so as to connect the second and third locations by a biarc.

For example, mobile robot 10 may be moved unexpectedly and deviate from the movement path due to, for example, influences in cases such as where the wheels of mobile robot 10 slip on the road surface or the road surface is an inclined surface. In such a case, for example, calculator 120 re-computes the movement path. Accordingly, even if mobile robot 10 is unexpectedly moved to the third location that is not on the first movement path, mobile robot 10 can reach the second location.

Technique 6 is calculation device 100 according to Technique 5, in which a location where two arcs of the biarc indicating the first movement path are joined together is defined as a first joint point and a location where two arcs of the biarc indicating the second movement path are joined together is defined as a second joint point, and in the case of computing the second movement path, if the first arc that connects the second joint point and the second location has a finite radius of curvature, the first arc being one of the two arcs of the biarc indicating the second movement path, calculator 120 locates the second joint point on a circle of a second arc that connects the first joint point and the second location, the second arc being one of the two arcs of the biarc indicating the first movement path, and if the first arc has an infinite radius of curvature, calculator 120 locates the second joint point on a straight line that passes through the first joint point and the second location.

This reduces throughput and enables computation of the first arc that is close to the second arc.

Technique 7 is calculation device 100 according to Technique 6, in which calculator 120 computes the third movement path so as to connect the second location and the third location by a biarc. In the case of computing the third movement path, calculator 120 locates a third joint point on a bisector of a line segment that connects the third location and the second location, the third joint point being a location where two arcs of the biarc indicating the third movement path are joined together. Moreover, (iv) if φ_{B}>φ_{C}, calculator 120 locates the third joint point to the right of the second location, as viewed from the third location; (v) if φ_{B}<φ_{C}, calculator 120 locates the third joint point to the left of the second location, as viewed from the third location; and (vi) if φ_{B}=φ_{C}, calculator 120 locates the third joint point on the line segment that connects the third location and the second location, where φ_{C} (−π φ_{C} n) is an angle indicating the orientation of mobile robot 10 at the third location with respect to a reference line, and φ_{B} (−π≤φ_{B}≤π) is an angle indicating the orientation of mobile robot 10 at the second location with respect to the reference line. Calculator 120 compares the second movement path and the third movement path, and determines the second movement path as the movement path of mobile robot 10 that moves autonomously from the third location to the second location when (vii) the length of the second movement path is shorter than the length of the third movement path that is multiplied by a first coefficient and (viii) an absolute value of the difference in curvature of the biarc indicating the second movement path is smaller than a value obtained by multiplying the absolute value of the difference in curvature between the two arcs of the biarc indicating the third movement path by a second coefficient.

That is, for example, in the case of re-computing the movement path, calculator 120 computes the movement path by using each of the calculation method described in Technique 2 and the calculation method described in Technique 6, and compares the computed movement paths to adopt a better movement path as the movement path.

Accordingly, for example, an appropriate movement path can be adopted even if the unnecessarily long second movement path is computed as shown in FIG. 20.

Technique 8 is mobile robot 10 that includes calculation device 100 according to any one of Techniques 1 to 7 and a controller that causes mobile robot 10 to move along the movement path computed by calculation device 100.

This allows mobile robot 10 to move autonomously along the movement path that can reduce throughput in autonomous movement of mobile robot 10. Accordingly, mobile robot 10 can reduce throughput in autonomous movement.

The present disclosure may also be realized as a calculation method that is processing executed by the calculation device. The present disclosure may also be executed as a program for causing a computer to execute the calculation method. The present disclosure may also be realized as a non-transitory computer-readable recording medium that stores the program. The present disclosure may also be realized as a control method for causing a mobile robot to move along the movement path computed by the calculation device. The present disclosure may also be realized as a program for causing a computer to execute the control method. The present disclosure may also be realized as a non-transitory computer-readable recording medium that stores the program.

### Other Embodiments

While the calculation device or the like according to the present disclosure has been described thus far in accordance with the above-described embodiment, the present disclosure is not intended to be limited to the above-described embodiment.

For example, according to the above-described embodiment, each processing unit is described as being realized by a CPU and a control program. For example, constituent elements of each processing unit may be configured by one or a plurality of electronic circuits. Each of the one or a plurality of electronic circuits may be a general-purpose circuit or a dedicated circuit. The one or a plurality of electronic circuits may include, for example, semiconductor devices, integrated circuits (IC), or large scale integration (LSI) circuits. ICs or LSI circuits may be integrated on a single chip, or may be integrated on a plurality of chips. Here, integrated circuits included in an electronic circuit are referred to as ICs or LSI circuits, but they may be named differently depending on the degree of integration and may also be referred to as system LSI, very large scale integration (VLSI), or ultra large scale integration (ULSI). A field programmable gate array (FPGA) programmed after manufacture of LSI circuits may also be used for the same purpose.

In the above-described embodiment, processing executed by a specific processing unit may be executed by a different processing unit. A sequence of a plurality of processing steps may be changed, or a plurality of processing steps may be executed in parallel.

Generic or specific aspects of the present disclosure may be realized as a system, a device, a method, an integrated circuit, or a computer program. These aspects may also be realized as a non-transitory computer-readable recording medium such as an optical disc, an HDD, or semiconductor memory that has recorded thereon the computer program. These aspects may also be realized as any combination of a system, a device, a method, an integrated circuit, or a recording medium.

The present disclosure also includes other variations obtained by making various modifications conceivable by those skilled in the art to the embodiment, and variations obtained by any combination of the constituent elements and functions of the embodiment without departing from the scope of the present disclosure.

### INDUSTRIAL APPLICABILITY

The present disclosure is applicable as an autonomous mobile robot.

1. A calculation device comprising:
an acquirer that acquires a first location and a second location different from the first location; and
a calculator that computes a first movement path of a mobile robot that moves autonomously from the first location to the second location,
wherein the calculator computes the first movement path to connect the first location and the second location by a biarc.

2. The calculation device according to claim 1,
wherein in the computing of the first movement path,
the calculator locates a joint point on a bisector of a line segment that connects the first location and the second location, the joint point being a location where two arcs of the biarc indicating the first movement path are joined together, and
(i) if φ_{B}>φ_{A}, the calculator locates the joint point to a right of the second location, as viewed from the first location;
(ii) if φ_{B}<φ_{A}, the calculator locates the joint point to a left of the second location, as viewed from the first location; and
(iii) if φ_{B}=φ_{A}, the calculator locates the joint point on a line segment that connects the first location and the second location,
where φ_{A} is an angle that indicates an orientation of the mobile robot at the first location with respect to a reference line, and φ_{B} is an angle that indicates the orientation of the mobile robot at the second location with respect to the reference line, where −π≤φ_{A}≤π and −π≤φ_{B}≤π are satisfied.

3. The calculation device according to claim 1,
wherein the acquirer acquires lattice information that indicates a plurality of lattice points, each indicating a location of the mobile robot and an orientation of the mobile robot at the location, and
the calculator computes the first movement path based on the lattice information to connect a first point and a current location of the mobile robot by a biarc and to connect the first point and a second point by a biarc, the first point being one of the plurality of lattice points, the second point being one of the plurality of lattice points other than the first point.

4. The calculation device according to claim 3,
wherein the acquirer acquires the lattice information by:
acquiring a plurality of first waypoints and numerical information, the plurality of first waypoints each indicating a location of the mobile robot and an orientation of the mobile robot at the location;
increasing a plurality of second waypoints by a number corresponding to a numerical value indicated by the numerical information, the plurality of second waypoints being different in location from the plurality of first waypoints; and
generating the lattice information in which the plurality of first waypoints and the plurality of second waypoints are used as the plurality of lattice points.

5. The calculation device according to claim 1,
wherein when a second movement path of the mobile robot that moves autonomously from a third location to the second location is computed after the computing of the first movement path, the calculator computes the second movement path based on the first movement path to connect the second location and the third location by a biarc, the third location being different from the first location and the second location.

6. The calculation device according to claim 5,
wherein a location where the two arcs of the biarc indicating the first movement path are joined together is defined as a first joint point, and a location where two arcs of the biarc indicating the second movement path are joined together is defined as a second joint point, and
in the computing of the second movement path,
if a first arc that connects the second joint point and the second location has a finite radius of curvature, the first arc being one of the two arcs of the biarc indicating the second movement path, the calculator locates the second joint point on a circle of a second arc that connects the first joint point and the second location, the second arc being one of the two arcs of the biarc indicating the first movement path; and
if the first arc has an infinite radius of curvature, the calculator locates the second joint point on a straight line that passes through the first joint point and the second location.

7. The calculation device according to claim 6,
wherein the calculator computes a third movement path to connect the second location and the third location by a biarc, in the computing of the third movement path,
the calculator locates a third joint point on a bisector of a line segment that connects the third location and the second location, the third joint point being a location where two arcs of the biarc indicating the third movement path are joined together,
(iv) if φ_{B}>φ_{C}, the calculator locates the third joint point to a right of the second location, as viewed from the third location,
(v) if φ_{B}<φ_{C}, the calculator locates the third joint point to a left of the second location, as viewed from the third location, and
(vi) if φ_{B}=φ_{C}, the calculator locates the third joint point on a line segment that connects the third location and the second location,
where φ_{C} is an angle that indicates an orientation of the mobile robot at the third location with respect to a reference line, and φ_{B} is an angle that indicates the orientation of the mobile robot at the second location with respect to the reference line, where −π φ_{C}≤π and −π≤φ_{B}≤π are satisfied, and
the calculator compares the second movement path and the third movement path, and determines the second movement path as the movement path of the mobile robot that moves autonomously from the third location to the second location when (vii) a length of the second movement path is shorter than a length of the third movement path that is multiplied by a first coefficient and (viii) an absolute value of a difference in curvature between the two arcs of the biarc indicating the second movement path is smaller than a value obtained by multiplying an absolute value of a difference in curvature between the two arcs of the biarc indicating the third movement path by a second coefficient.

8. A mobile robot comprising:
the calculation device according to claim 1; and
a controller that causes the mobile robot to move along the movement path computed by the calculation device.
